(19) United States
(12) Patent Application Publication
(10) Pub. No.: US 2016/0070872 A1
(43) Pub. Date: Mar. 10, 2016

(54) APPARATUS AND METHODS FOR MANAGING MEDICATION DOSING CONTENT IN AN ELECTRONIC ANESTHESIA RECORD

(71) Applicant: David Michael Glenn, Menlo Park, CA (US)

(72) Inventor: David Michael Glenn, Menlo Park, CA (US)

(73) Assignee: David Michael Glenn, Menlo Park, CA (US)

(21) Appl. No.: 14/523,858

(22) Filed: Oct. 25, 2014

Related U.S. Application Data
(60) Provisional application No. 61/896,109, filed on Oct. 27, 2013.

(51) Int. Cl. G06F 19/00; G06F 3/0481; G06F 3/0484; G06F 3/0488

(52) U.S. Cl. CPC G06F 19/3406; G06F 19/3456; G06F 3/0488; G06F 3/0481; G06F 3/0484

(57) ABSTRACT

An apparatus and method for managing medications via gesture-based means in an electronic anesthesia record on a multi-functional device with a gesture-sensitive interface.

### CROSS REFERENCE TO RELATED APPLICATIONS

This application claims priority under 35 U.S.C. §119 (e) to U.S. provisional patent application Ser. No. 61/896,109 filed on Oct. 27, 2013, the contents of which is hereby incorporated herein by reference in its entirety for all purposes.

### COPYRIGHT NOTICE

Pursuant to 37 C.F.R. 1.71(e), applicants note that a portion of this disclosure contains material that is subject to and for which is claimed copyright protection, such as, but not limited to, copies of paper forms, screen shots, user interfaces, electronic medical record formats, or any other aspects of this submission for which copyright protection is or may be available in any jurisdiction. The copyright owner has no objection to the facsimile reproduction by anyone or the patent document or patent disclosure, as it appears in the Patent Office patent file or records. All other rights are reserved, and all other reproduction, distribution, creation of derivative works based on the contents, public display, and public performance of the application or any part thereof are prohibited by applicable copyright law.

### STATEMENT REGARDING FEDERALLY SPONSORED RESEARCH OR DEVELOPMENT

None.

### THE NAMES OF PARTIES TO A JOINT RESEARCH AGREEMENT

None.

### FIELD OF INVENTION

This invention relates to an improved technique for managing medications via gesture-based means in an electronic anesthesia record.

### BACKGROUND OF THE INVENTION

The introduction of electronic anesthesia record (“record”) systems was attempted as early as in 1979, although their efficient application has become reality only in the past few years. The advantages of the electronic interface over paper are apparent: reduction of paper, electronic storage of records, graphical user interfaces, consolidation of functions, analytics and trending, ease of use and quick functional updates. Given the complexity of even routine physiological monitoring in contemporary surgical practice, digital systems offer the ability to collect the large volume of perioperative patient information needed for surgical and critically ill patients. An AIMS automatically creates a clinical anesthesia record, generates specialized patient-specific reports for clinical care and billing, and builds an electronic database and searchable repository of physiological and demographic data. An AIMS also makes it possible for anesthesiologists and institutions to meet the increasing demands for legible, comprehensive, secure, and shareable perioperative clinical documents. Despite these challenges, many institutions still rely on paper-based solutions in spite of the electronic advancements of the past two decades. Adoption remains a paramount challenge.

At the heart of this adoption problem is human computer interfacing. Many AIMS systems present significant human-computer functional and usability problems which burden the anesthesiologist while in the operating room. In that setting, the anesthesiologist is required to operate machinery that delivers medications to the patient (such as a mask and a respiration bag), monitor the patients vital signs, keep his/her eyes on the patient to carefully monitor outward physiological states, pay attention and participate in the actions and conversations between doctors and nurses. In addition to basic measurements, such as pulse, blood pressure and temperature, anesthesiologists also measure the patient's respiration. If the patient is under a general anesthetic, the anesthesiologist measures the volume the patient inhales and the carbon dioxide level exhaled. During some procedures, the anesthesiologist must monitor the volume of blood being pumped by the heart, nerve functions or the blood pressure inside the patient's lungs. If the procedure requires the use of special monitors, such as arterial catheters, the anesthesiologist is typically responsible for placing them. Anesthesiologists also ensure that patients remain in the proper position, such as keeping the patient's head aligned during neck surgery.

Many prior art AIMS require the anesthesiologist to use both hands to input data during the procedure. This is because they rely on both a keyboard and mouse or some inefficient combination there of. Some AIMS do enable a form of touch sensitivity, however, their reliance of standard UI controls limit the user experience. In one example of the prior art, when the anesthesiologist wants to enter a medication dosage, he touches the screen and the application pops up a text entry field where he must type a value with a physical keyboard. In another example, the anesthesiologist will touch the screen and to change the default dosage he must use a mouse or tap a scroller on a combo box or other UI control to arrive at the desired value. Many prior art systems rely on a hybrid interfacing means of mouse and keyboard and touch screen, leaving with anesthesiologist with a difficult experience. Worse still, some prior art solutions also require significant space for the monitor, CPU, keyboard holder and mouse pad, making their placement in the crowded operating room cumbersome for all medical personal. This is made more difficult by the fact that the anesthesiologist is often required to input data on many types of medications being administered, many different vital signs being monitored, and many different types of blood pressures being tracked. To help deal with this deluge of real-time information, most prior art AIMS collect data directly and sometimes exclusively through machine interfaces to the equipment present in the operating room.

In this approach, the machine interface may produce a large amount of artifactual data that is irrelevant or spurious. This information, if recorded into a permanent record, may convey a false picture of the medical facts present in the case. Additionally, doctors prefer the ability to add, edit, or delete values based on their perception and clinical interpretation of the data and at times of their choosing and when it is clinically appropriate and safest for patient care to do so. In some prior art AIMS the anesthesiologist is only presented with a read-only interface to the data being collected. No editing is permitted. Some of these have gone so far as to present a web based, read-only interface formatted to look appropriate for a tablet interface.

Finally, irrespective of the approach, many AIMS simply lack functions often desired but difficult to achieve with conventional interfacing. They include:
Complete access and control of AIMS features via one hand event without a mouse.
A tablet based form factor.
An ability to input multiple medications, with individual types distinguished by color with the ability to add, edit, undo and delete values via a single hand gesture
An ability to store and retrieve medications based on a template.
An ability to visually track time related to multiple events of the case.

Recent advances in tablets and gesture control driven multi-functional devices has enabled another radical advancement in the usability of AIMS, much of which still remains unexplored by the prior art.

### SUMMARY OF THE INVENTION

The present invention focuses on the problem of managing medications in an electronic anesthesia record through a unique combination of gesture controls on a multi-function gesture-sensitive device. It is a graphical user interface apparatus and a method for displaying, entering, editing, deleting and organizing one or more types of medications and related information collected over the life of an electronic anesthesia record. In one embodiment, the graphical user interface is presented to the user by an application program that runs on the multi-function device.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description of specific embodiments presented herein. The patent or application file contains at least one drawing executed in color. Copies of this patent or patent application publication with color drawing(s) will be provided by the Office upon request and payment of the necessary fee.

FIG. 1 shows the invention and its respective sub-views and their relationship to the electronic anesthesia record as a whole.

FIG. 2A-FIG. 2B show representations of the fourth sub-view of the graphical user interface apparatus.

FIG. 2A shows the fourth sub-view of the graphical user interface apparatus.

FIG. 2B shows the fourth sub-view of the graphical user interface apparatus.

FIG. 3 shows the how the invention represents continuously dosed medications.

FIG. 4A-FIG. 4C show representations of the first default dose information for a given medication being added at current time.

FIG. 4A shows the anesthesiologist adding first default dose information for a given medication at current time.

FIG. 4B shows the anesthesiologist adding second default dose information for a given medication at current time.

FIG. 4C shows the anesthesiologist adding third default dose information for a given medication at current time.

FIG. 5A-FIG. 5E shows the anesthesiologist adding custom dose information for a given medication not at current time via gesture-based means.

FIG. 5A shows the anesthesiologist initiating the process of adding a custom dose via gesture-based means.

FIG. 5B shows the anesthesiologist increasing the dose by a preconfigured increment via gesture-based means.

FIG. 5C shows the anesthesiologist increasing the dose by a preconfigured increment via gesture-based means.

FIG. 5D shows the anesthesiologist increasing the dose by a preconfigured increment via gesture-based means.

FIG. 5E shows the result of the completed process of entering a custom dose via gesture-based means.

FIG. 6A-FIG. 6B shows the anesthesiologist editing previously recorded medication dosing content via gesture-based means.

FIG. 6A shows the anesthesiologist initiating the process of editing a previously recorded medication via gesture-based means.

FIG. 6B shows the anesthesiologist performing the process of editing a previously recorded medication via gesture-based means.

FIG. 7A-FIG. 7D shows the anesthesiologist deleting previously recorded medication dosing content via gesture-based means.

FIG. 7A shows the anesthesiologist initiating the process of deleting previously recorded medication doses via gesture-based means.

FIG. 7B shows the medication doses the anesthesiologist is interested in deleting.

FIG. 7C shows the anesthesiologist performing the process of deleting previously recorded medication doses via gesture-based means.

FIG. 7D shows the anesthesiologist completing the process of deleting previously recorded medication doses via gesture-based means.

FIG. 8A-FIG. 8I shows the anesthesiologist changing the time resolution via gesture-based means.

FIG. 8A shows two representative doses which if not handled properly by the application program will result in an ambiguous representation.

FIG. 8B shows two representative doses, the application program will render the doses distinctly to prevent an ambiguous representation. In this case, the application program renders one dose shifted up and the other shifted down.

FIG. 8C shows two representative doses, the application program will render the doses distinctly to prevent an ambiguous representation. In this case, the application program will merge the values into a single summed value.

FIG. 8D shows two representative doses, the application program will render the doses distinctly to prevent an ambiguous representation. In this case, the application program will unmerge the values from a single summed value to two distinct values.

FIG. 8E shows a birds-eye view of the timeline of the case with the portion viewable to the anesthesiologist. The portion viewable to the anesthesiologist is changeable via horizontal scrolling. Shifted areas appear as 1-minute intervals while the remainder of the case, as 5-minute intervals.

FIG. 8F explains the before and after effect of changing the time resolution via gesture-based means.

FIG. 8G explains the before and after effect of changing the time resolution via gesture-based means.

FIG. 8H explains the before and after effect of changing the time resolution via gesture-based means.

FIG. 8I explains the before and after effect of changing the time resolution via gesture-based means.

FIG. 9A-FIG. 9C shows the anesthesiologist performing horizontal and vertical scrolling of the application via gesture-based means.

FIG. 9A demonstrates the anesthesiologist performing a horizontal scrolling gesture to the right moving the current view of the case to a previous time.

FIG. 9B demonstrates the anesthesiologist performing a horizontal scrolling gesture to the left moving the current view of the case to a later time.

FIG. 9C demonstrates the anesthesiologist performing a vertical scrolling gesture to the left moving the current view of the case to a later time.

FIG. 10 shows the anesthesiologist performing a vertically split of the medication grid into two horizontal regions via gesture-based means.

FIG. 11A-FIG. 11B shows a series of actions taken by the anesthesiologist to perform an expand and magnify function for a given screen area via gesture-based means.

FIG. 11A shows the anesthesiologist performing an expand and magnify function for a given screen area via gesture-based means.

FIG. 11B shows the invention in changed presentation modes.

FIG. 12A-FIG. 12D shows the invention in changed presentation modes.

FIG. 12A shows the invention in a particular presentation mode.

FIG. 12B shows the invention in a particular presentation mode.

FIG. 12C shows the invention in a particular presentation mode.

FIG. 12D shows the invention in a particular presentation mode.

FIG. 13A-FIG. 13L shows the anesthesiologist adding new dosing information, and then undoing and redoing part of them via gesture-based means.

FIG. 13A shows the anesthesiologist adding new dose information them via gesture-based means.

FIG. 13B shows the anesthesiologist adding new dose information them via gesture-based means.

FIG. 13C shows the anesthesiologist adding new dose information them via gesture-based means.

FIG. 13D shows the anesthesiologist adding new dose information them via gesture-based means.

FIG. 13E shows the anesthesiologist adding new dose information them via gesture-based means.

FIG. 13F shows the anesthesiologist adding new dose information them via gesture-based means.

FIG. 13G shows the anesthesiologist undoing doses previously added in a last added first undone order via gesture-based means.

FIG. 13H shows the anesthesiologist undoing doses previously added in a last added first undone order via gesture-based means.

FIG. 13I shows the anesthesiologist undoing doses previously added in a last added first undone order via gesture-based means.

FIG. 13J shows the anesthesiologist redoing doses previously undone in a last undone first redone order via gesture-based means.

FIG. 13K shows the anesthesiologist redoing doses previously undone in a last undone first redone order via gesture-based means.

FIG. 13L shows the anesthesiologist redoing doses previously undone in a last undone first redone order via gesture-based means.

FIG. 14 shows the sixth sub-view of the apparatus invention.

FIG. 15 shows the drug editor sub-view of the apparatus invention.

### DETAILED DESCRIPTION OF THE INVENTION

The above deficiencies and other problems associated with managing blood pressure vital sign information in an electronic anesthesia record are reduced or eliminated by the disclosed apparatus and methods. In all embodiments, the device has a gesture-sensitive display with a graphical user interface (GUI) produced by an application program operating on the portable multi-function device, one or more processors, memory and one or more modules, programs or sets of instructions stored in the memory for performing multiple functions. In some embodiments, the user interacts with the GUI primarily through touch gestures such as one or more fingers, from the same hand, directly contacting the gesture-sensitive interface, however other means may also include, but not limited to, kinetic motion gestures or even audio command, sounds or phrases, all of which are considered gesture enablers and hence equivalent. Instructions for performing these functions may be included in a computer program product configured for execution by one or more processors.

It shall be understood that, although the terms first, second, etc. used herein to describe various elements, these elements should not be limited to these terms. These terms are only used to distinguish one element from another. The terminology used in the description of the invention herein is for the purpose of describing particular embodiments only and is not intended to be limiting of the invention.

The word “manage” shall be construed to comprise the functions of display, add, edit, delete, and organize medication dose content and the graphical user interface effects that enable those functions within the context of an electronic anesthesia record.

As used in the description of the invention and the appended claims, the singular forms “a”, “an” and “the” are intended to include the plural forms as well, unless the context clearly indicates otherwise. The term “plurality” is taken to mean zero to many occurrences.

It will also be understood that the term “and/or” as used herein refers to and encompasses any/all possible combinations of one or more of the associated listed items.

The terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The use of particular gestures is representative only and the reliance of touch-sensitivity is not a requirement as other means of enabling gestures may presently or in the future be possible. It is not implied that the use of the word “gesture” excludes the possibility of a combination of other gestures even of varying types.

The invention does not rely on any particular implementation of a multi-functional, gesture-sensitive device or any version of its operating system and any graphics displayed is not intended to convey a reliance on any particular vendor or version thereof. It shall be understood, that a person of ordinary skill in the art, if given a stock operating system could implement the various embodiments of the invention and the stock operating system has not been modified in any way by the invention, sometimes referred to as “hacks”, “jailbreaks”, “rooting” or “privilege escalations” to name a few.

It should be noted that the use of terminology such as window, sub-window, view and sub-view are representative of a concept in graphical user interface programming and are not limited in any way to one particular vendors approach. Some vendor's application programming interfaces (API) use terms like window/sub-window or panel/sub-panel. All are equivalent and exchangeable herein and convey a logical rather than a physical function, which a person of ordinary skill in programming a particular vendor's API could implement without undue experimentation.

The American Society for Testing and Materials (ASTM) has developed a standard (Standard D 4774-94) for “user applied” syringe drug labels in anesthesiology. The ASTM standard assigns a specific color to each class of anesthetic drug. The standard background colors for user applied syringe drug labels are in TABLE 1.

TABLE 1
Background color for user applied syringe labels. Standard
specifications for user applied drug labels in anesthesiology
(ASTM Standard No. D 4774-94).
West Conshohocken, PA: American Society for Testing and
Materials. Available through the ATSM website at www.astm.org.

| Drug Class | Examples | Pantone Color |
|---|---|---|
| Induction agents | Thiopental, | Yellow |
| | Methohexital, | |
| | Thiamylal, | |
| | Etomidate, | |
| | Proporol, | |
| | Ketamine | |
| Tranquillizers | Diazepam, | Orange 151 |
| | Midazolam | |
| Muscle relaxants | Succinylcholine, | Fluorescent red 805 |
| | Curare | |
| | Mivacurium, | |
| | Vecuronium, | |
| | Atracurium, | |
| | Pancuronium | |
| Relaxant | Neostigmine, | Fluorescent red 805 or warm |
| antagonist | Edropronium, | red and white diagonal stripes |
| | Pyridostigmine | |
| Narcotics | Morphine, | Blue 297 |
| | Fentanyl, | |
| | Meperidine | |
| Narcotics | Levallorphan, | Blue 297 and white diagonal |
| antagonists | Naloxone | stripes |
| Major | Droperidol, | Salmon 156 |
| tranquillizers | Chlorpromazine | |
| Combinations of | Innovar, | Blue 297 and white |
| narcotics and | Fentanyl- | longitudinal stripes |
| major | Droperidol | |
| tranquilizers | combination | |
| Vasopressors | Epinephrine, | Violet 256 |
| | Ephedrine, | |
| | Phenylephrine | |
| Hypotensive | Trimethaphan, | Violet 256 and white diagonal |
| agents | Nitroprusside, | stripes |
| | Nitroglycerine, | |
| | Phentolamine | |
| Local | Bupivacaine, | Grey 401 |
| anesthetics | Lidocaine | |
| Anticholinergic | Atropine, | Green 367 |
| agents | Glycopyrrolate | |
| Anti-emetics | Droperidol, | Salmon 156 |
| | Metoclopramide | |

The administration of a wrong drug is an anesthetic nightmare. The possibility of drug errors is greater in anesthesia medicine than in any other because of the number of different drugs and syringes involved. Drug labels contribute as misidentification of syringes similar in color and text are common. Additional factors including, the doctor fatigue, haste and inattention, also contribute. The syringe drug labels are an important safety factor in the correct identification and administration of drugs. The AS/NZS standards and ASTM specify precisely the type, color and positioning of lettering to be used on the syringe labels. The type of letters, their font, their color, and their relationship to the background colors must be specified clearly. The font is 10 point in size or above and the letters are always black. The letters are written at the upper top half of the label leaving the lower half for insertion of the concentration. The letters are sometimes all in upper case although it is well known that they are difficult to read; a combination of upper and lower case letters facilitates both reading and identification of a drug.

In prior-art electronic anesthesia record applications, the process of selecting medications is challenged due to their antiquated nature. Most are based on older mouse based GUIs and are built to model the non-electronic paper based data entry means and lack color coordination to the D 4774-94 standard.

An electronic anesthesia record has two modes, active and completed. A record is completed only when an anesthesiologist signs off on the record, making it a legal document, after which only addendums can be made, but no edits. The invention pertains to actions what occur when the record is in the active mode. This is when the patent is under some phase of medical treatment requiring an anesthesiologist.

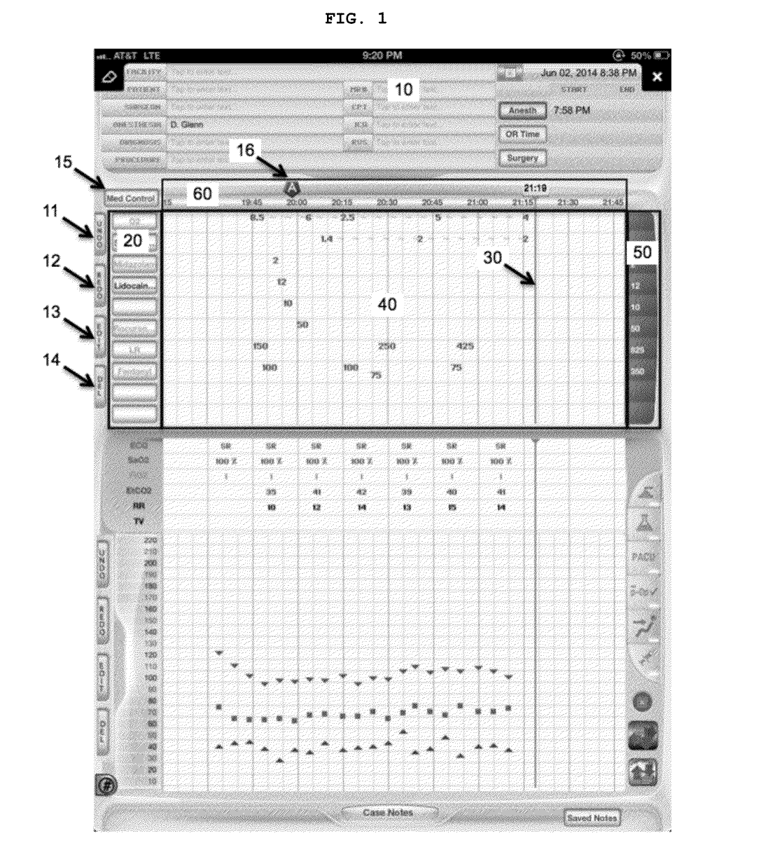

The electronic anesthesia record (FIG. 1) is both an apparatus and a plurality of computer-implemented methods used in conjunction with a portable multifunction device with a gesture-sensitive display and reduced to practice in the form of an application program. The application program displays an application program window (FIG. 1, 10).

In one embodiment of the present invention, the application program operatively enables, via gesture-based means, a graphical user interface apparatus to manage the medications dosed to a patient over the duration of a procedure. The apparatus contains a first, second, third, fourth, fifth and sixth sub-view.

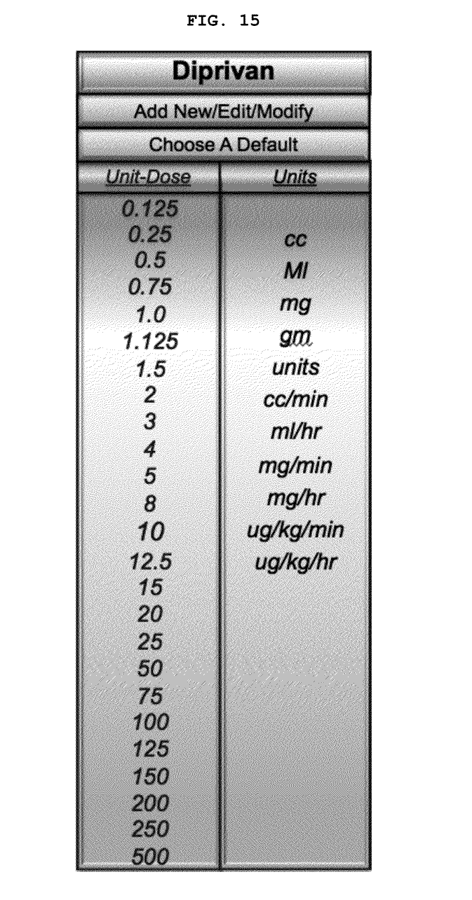

The first sub-view (FIG. 1, 20) displays a vertical set of user interface controls, one user interface control per medication the anesthesiologist will dose during the record. The user interface control's label displays the name of the medication and the color of the label will match the color assignment detailed in TABLE 1 based on the class the drug belongs. Each user interface control serves several purposes.
1. If the anesthesiologist has configured a medication to the user interface control, then when gestured, the application program will record that the anesthesiologist applied the default dose to the patient at current time (FIG. 1, 30).
2. If the anesthesiologist has configured a medication to the user interface control, then when gestured, the application program will open the drug editor sub-view to edit the dosing information for the medication (FIG. 15).
3. If the anesthesiologist has not configured a medication to the user interface control, then when gestured, the application program will open the sixth sub-view (FIG. 14).

The second sub-view (FIG. 1, 40), arranged to the right of the first sub-view, displays at least a portion of the medication grid containing rows and columns. The rows represent distinct medications and the columns represent time increments advancing forward in time from left to right. The medication grid is a record of all medications dosed to the patent over the life of the electronic anesthesia record. The application program aligns the rows of the second sub-view to the buttons displayed in the first sub-view such that they act as row headers to identify the medication for a given row. Additionally, the second sub-view has three operational modes;

Default, displayed in a first background color.

Edit, displayed in a second background color.

Delete, displayed in a third background color.

By default, the second sub-view is in Default mode. Note, time-shifted regions of the second sub-view are shown in a fourth color.

The third sub-view (FIG. 1, 50), arranged to the right of the second sub-view, displays for each row, a sum of the doses delivered for a given medication. Any time the anesthesiologist adds, modifies, or deletes a dose for a medication, the application program makes a corresponding change in the third sub-view for its respective row.

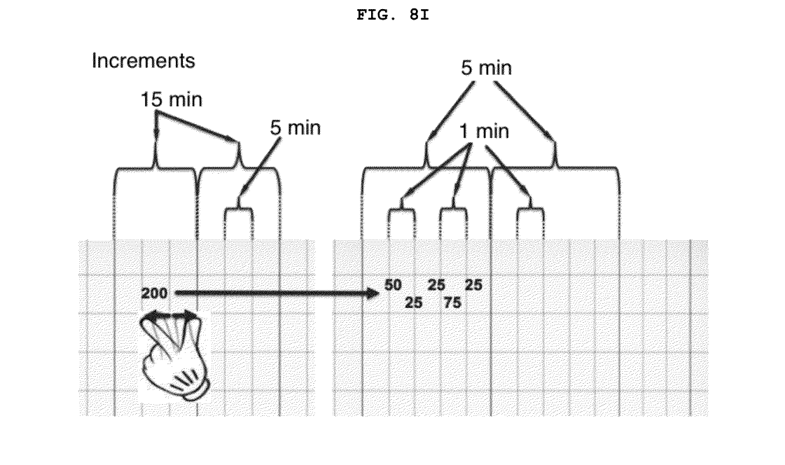

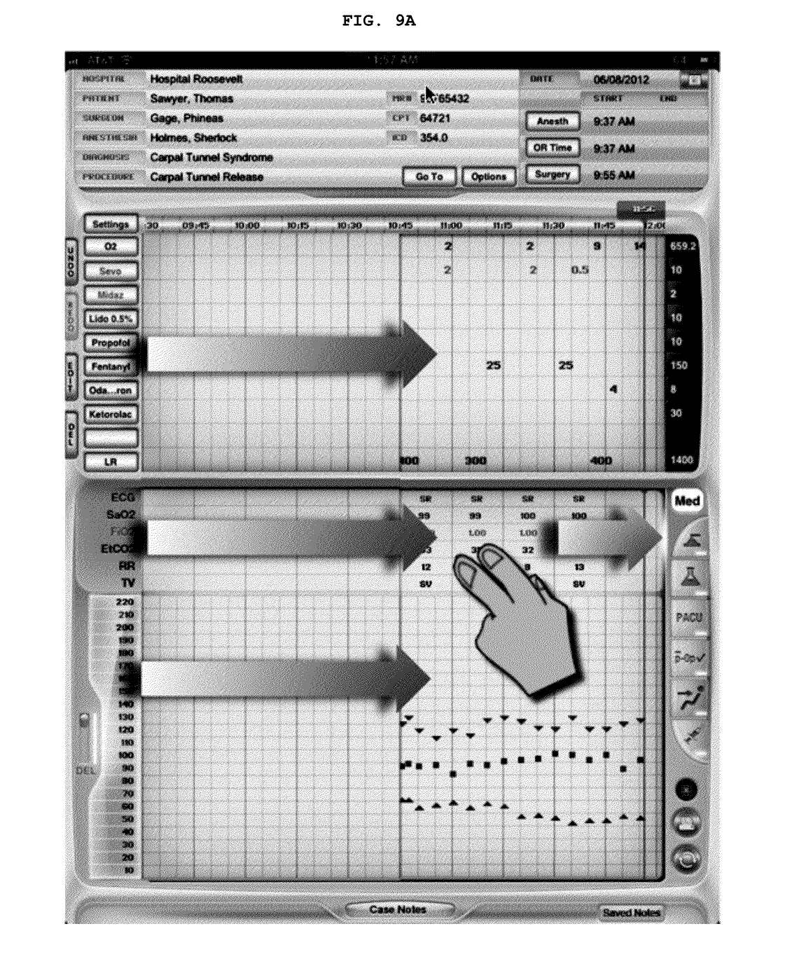

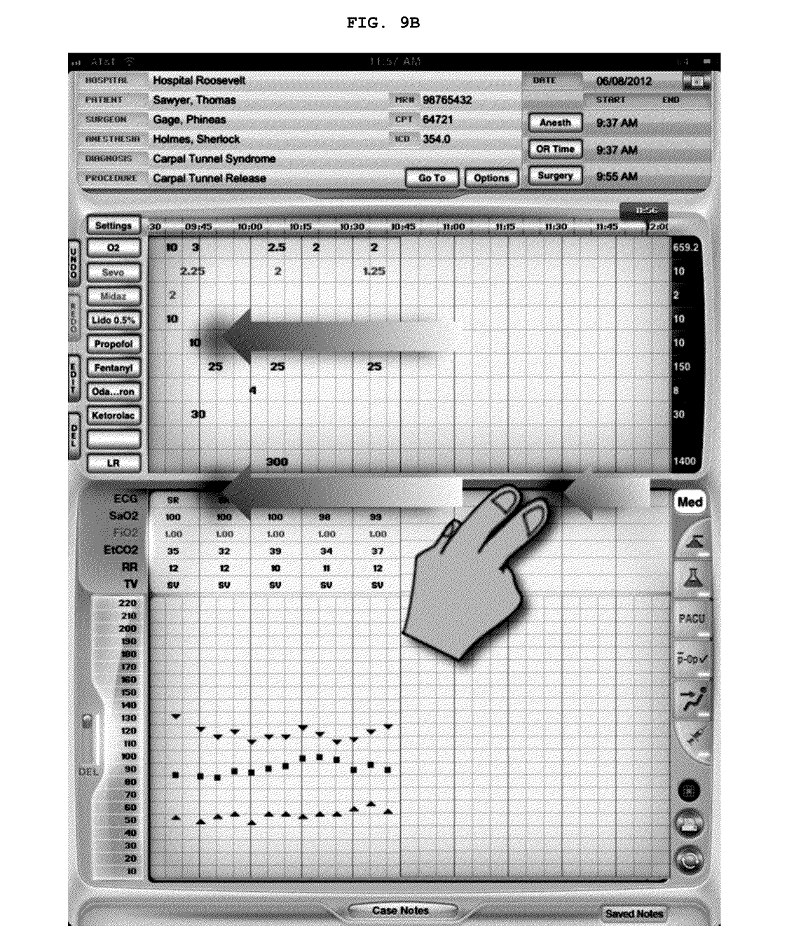

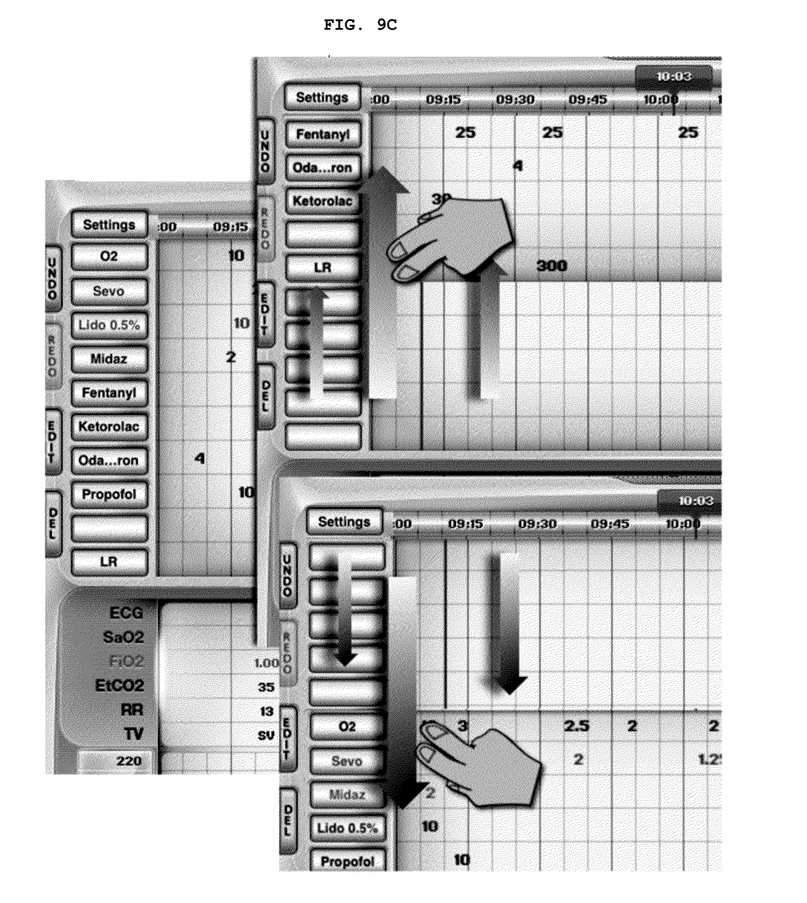

Collectively and uniformly, the first, second, and third sub-views are vertically scrollable via a gesture (FIG. 9C). The application program enables the anesthesiologist to manage more medications than are displayable at once in the second sub-view, hence the need for vertical scrolling.

The fourth sub-view displays a timeline of the electronic anesthesia record based on time of day (FIG. 1, 25) with a plurality of time increments vertically aligned to the columns of the second sub-view. To change the time under view in the second sub-view, the anesthesiologist can horizontally scroll right (back in time) (FIG. 9A) or horizontally scroll left (forward in time) (FIG. 9B). It is important to note, that the timeline displayed by the application program in the fourth sub-view is time of day and not elapsed time. The fourth sub-view also provides a means of visually tracking time-based events related to the electronic anesthesia record as icons, such as, but not limited to the anesthesia start time, operating room entry time and surgical incision time (FIG. 1, 16). A more complete, non-comprehensive list of time-based events the application program is capable of tracking is listed in TABLE 2.

TABLE 2

| EVENT NAME | DESCRIPTION |
|---|---|
| Anesthesia Start Time | Time the anesthesiologist assumes |
| | responsibility for the care of the patient |
| Operating Room Entry Time | The time the patient physically enters the |
| | operating room |
| Anesthesia Turn-Over Time | The time after the anesthesiologist has |
| | induced anesthesia such that the surgery |
| | can proceed. This is when the surgical |
| | nurses can now start prepping the surgical |
| | site on the patient |
| Turnover to Surgeon Time | Time when surgical nurses finish prepping |
| | and surgeons can begin. |
| Surgical Incision Time | The time the surgeon makes an invasive |
| | maneuver or intervention, i.e. scalpel |
| | incision to the skin, injection of |
| | medication in the surgical site |
| Surgery Finish Time | The time when the surgeon is finished with |
| | any invasive maneuver or intervention but |
| | before he/she, the surgical assistant or |
| | nurse begins applying the surgical wound |
| | dressings or casts, etc. |
| Surgical Finish Time | The time the surgeon, surgical assistants, |
| | or nurses finishes applying the surgical |
| | wound dressings or casts, etc. |
| Anesthesia Emergence Time | The time when the anesthesiologist begins |
| | to wake up the patient this typically but |
| | not always starts at the end of the |
| | surgical finish time, sometimes there is |
| | overlap |
| OR End Time | The time the patient physically leaves the |
| | operating room |
| PACU Start Time | The time the patient enters the post- |
| | anesthesia care unit, (recovery room) |
| Anesthesia End Time | The time the anesthesiologist finishes the |
| | anesthesia care of the patient by |
| | transferring the responsibility of the |
| | care of the patient over to the recovery |
| | (PACU) nurses |

There are two primary reasons the application program tracks time-based events.
The time an anesthesiologist spends in a particular event influences his/her compensation. The general rule being, more time, more compensation.
For regulatory reasons, the occurrence of particular events must be tracked to ensure that they occur and that they occur in a particular order.

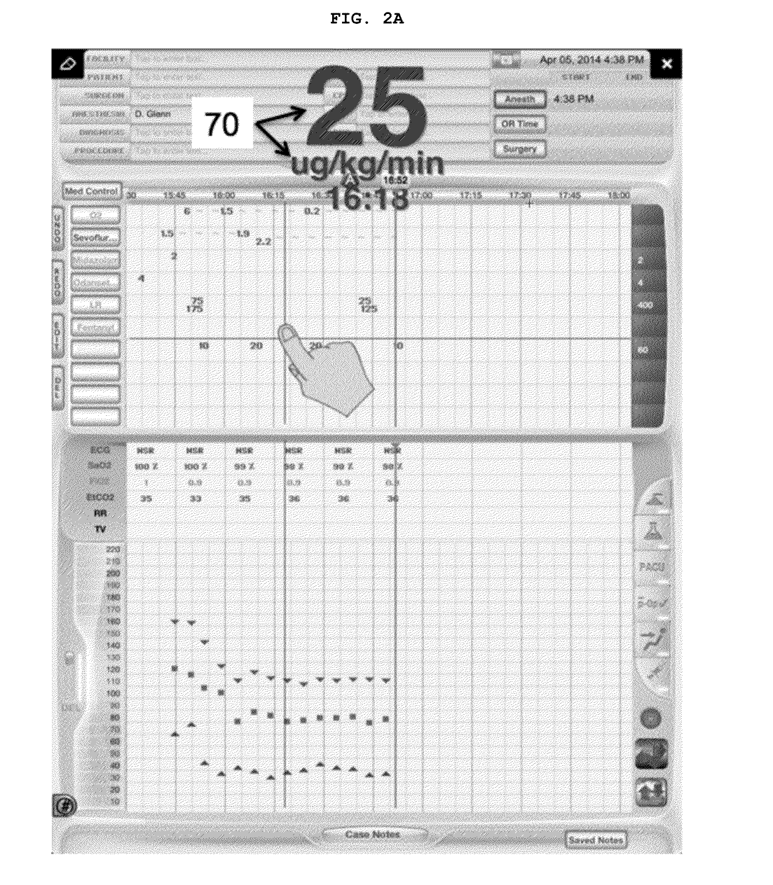

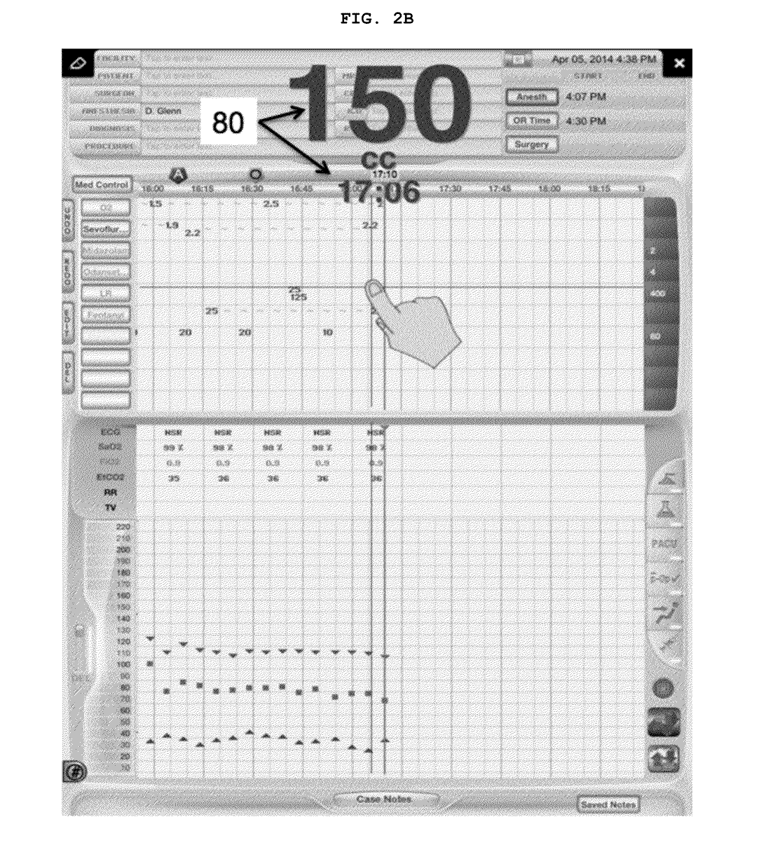

The fifth sub-view will display information under gesture near the top of the application program window (FIG. 2A, 70, FIG. 2B, 80). When the anesthesiologist is performing a gesture such as a touch and hold or single finger slide in the second sub-view, it is difficult to know what value, along with its corresponding units, is under gesture simply because the exact grid position is not visible to the anesthesiologist through his/her finger. In addition, a finger is not a precise instrument so it would be difficult for the anesthesiologist to “sense” the value under gesture. The data shown in the fifth sub-view allows the anesthesiologist to focus on performing the gesture while easily seeing its corresponding value with units. As the gesture progresses, the information displayed in the fifth sub-view updates in real-time. When the gesture ends, the application program hides the fifth sub-view. The application program displays the fifth sub-view near the top of the application program window because it obstructs the least important data the anesthesiologist needs during a surgery, which is the patient name, medical coding info, etc. Once a gesture begins, and the anesthesiologist is managing real-time medication content, this information is not relevant. Less useful choices of placement include near the focus of the gesture and it would “float” as the gesture progresses. This has the potential of blocking needed information.

The sixth sub-view (FIG. 14) will display a means for configuring medications the application program will manage. Medical procedures commonly performed have a recurring plurality of the same medications. The application program, via the sixth sub-view, enables the anesthesiologists to select these medications individually or as a set, called a med-set. Precisely, a med-set is the set comprising one or more medications and their associated unit-doses, which the anesthesiologists can optionally modify on a per record basis. The application program will provide “factory preset” med-sets, which are non-deletable except by a user with administrative authority. The anesthesiologist can also change the unit-dose or units for a medication and save the modified unit-dose for future use. The sixth sub-view organizes medications into drug classes. A drug classes have the following characteristics:
The background color of a drug class is selected based on the D 4774-94 standard from the ASTM. Other drug classes outside the standard are configurable by the anesthesiologist.
A drug class is vertically scrollable via a gesture-based means (two finger slide) up or down.
A drug class contains the name of the drug and the default unit-dose and unit.
The sixth sub-view can be horizontally scrollable to reveal more drug classes via a gesture (two finger slide) to the left or right.
The choice of color for a given drug class is changeable.

In another embodiment of the invention, the application program operatively enables a process to allow the anesthesiologist, via gesture-based means, to add at least one default dose of a medication at current time on a multi-function gesture-sensitive device. Based on the type of medication, the anesthesiologist may dose the patient either discretely or continuously. For example, O₂ is applied continuously through a breathing mask while Midazolam is applied discretely. When a medication is applied continuously, the application program will fill the spaces between doses with “˜” characters (FIG. 3). The notation implies that the dosage continues until the anesthesiologist changes the dosage at which time the application program displays the new dosage.

TABLE 3

| | AFTER 1^{st} | AFTER 2^{nd} | AFTER 3^{rd} |
|---|---|---|---|
| | GESTURE | GESTURE | GESTURE |
| | VALUE | VALUE | VALUE |
| DEFAULT DOSE | DISPLAYED | DISPLAYED | DISPLAYED |
| MEDICATION A | 5 | 10 | 15 |
| 5 ug/kg/min | | | |
| MEDICATION B | 150 | 300 | 450 |
| 150 cc | | | |

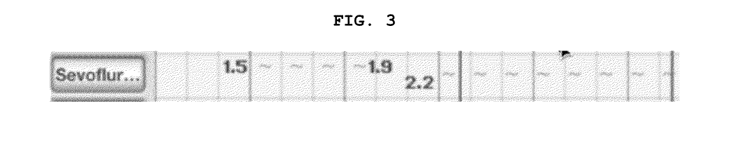

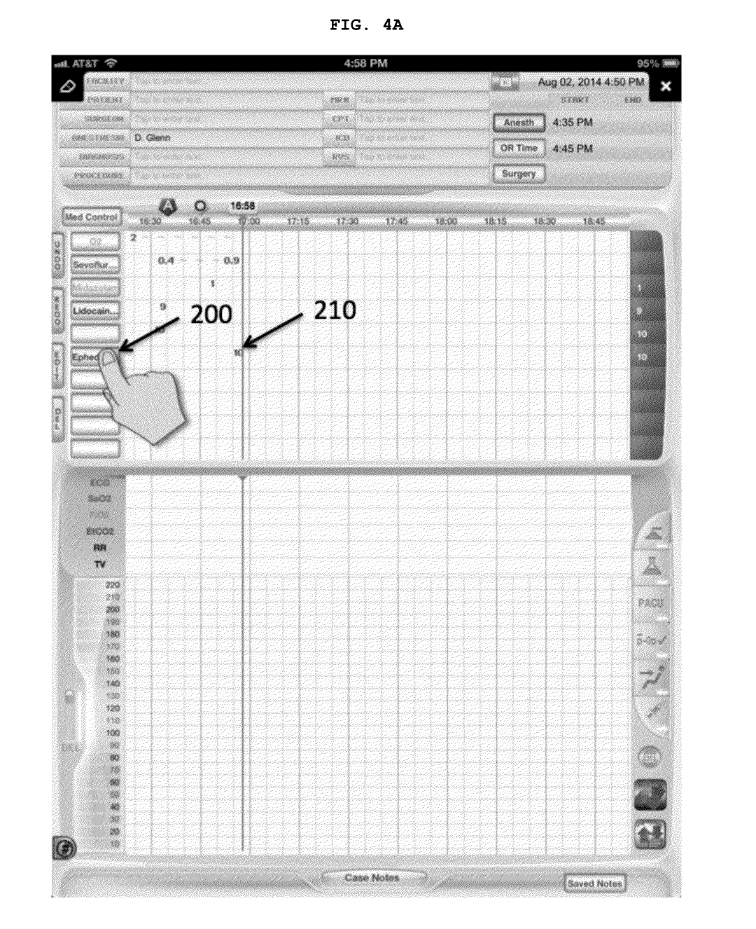

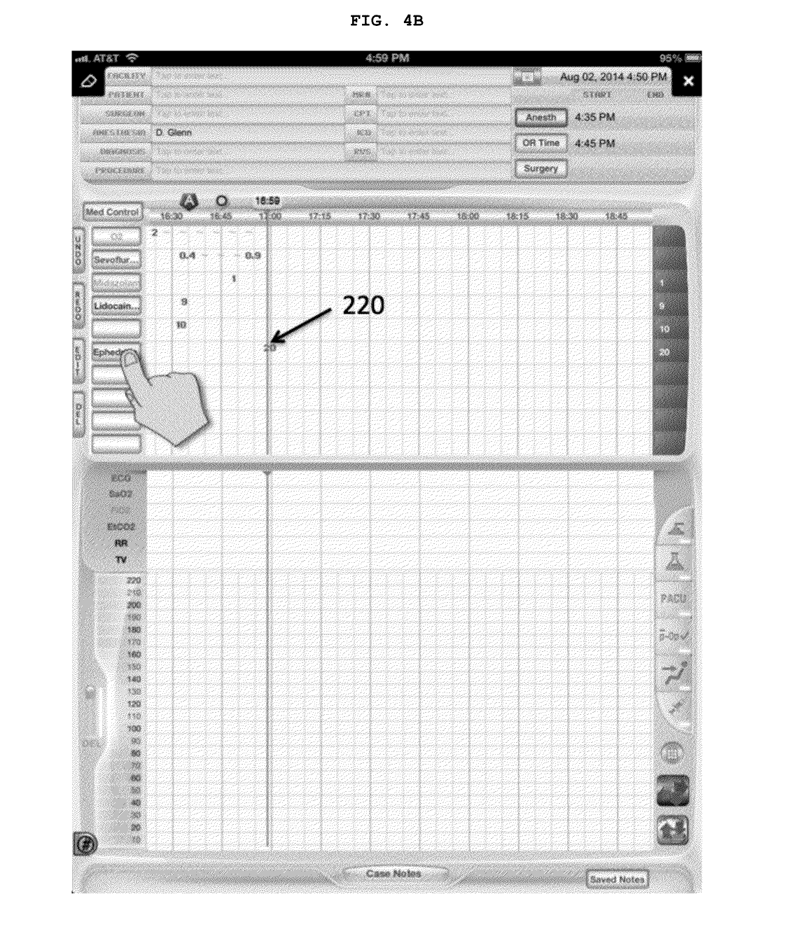

If the anesthesiologist gestures again before current time advances, the application program will add another default dose to the previous dose recorded. The anesthesiologist will perform the following process for adding a new dose of a medication under management:
The anesthesiologist performs a first gesture (single-finger tap) on a user interface control in the first sub-view (FIG. 4A, 200) that he/she has configured for a given medication. The application program will display the default first dose configured for the medication at current time (FIG. 4A, 210). Additionally, the application program will increment the sum of all doses applied for the medication in the third sub-view, adding the default dose.
If the anesthesiologist wants to add a second default dose at current time, then he/she will performs the first gesture again and the application program will add the second dose to the first dose, and display the sum (FIG. 4B, 220). The anesthesiologist can repeatedly apply this step for each additional dose applied at current time (FIG. 4C, 230). See TABLE 3. Again, the application program will increment the sum of all doses applied for the medication in the third sub-view, adding each additional default dose.

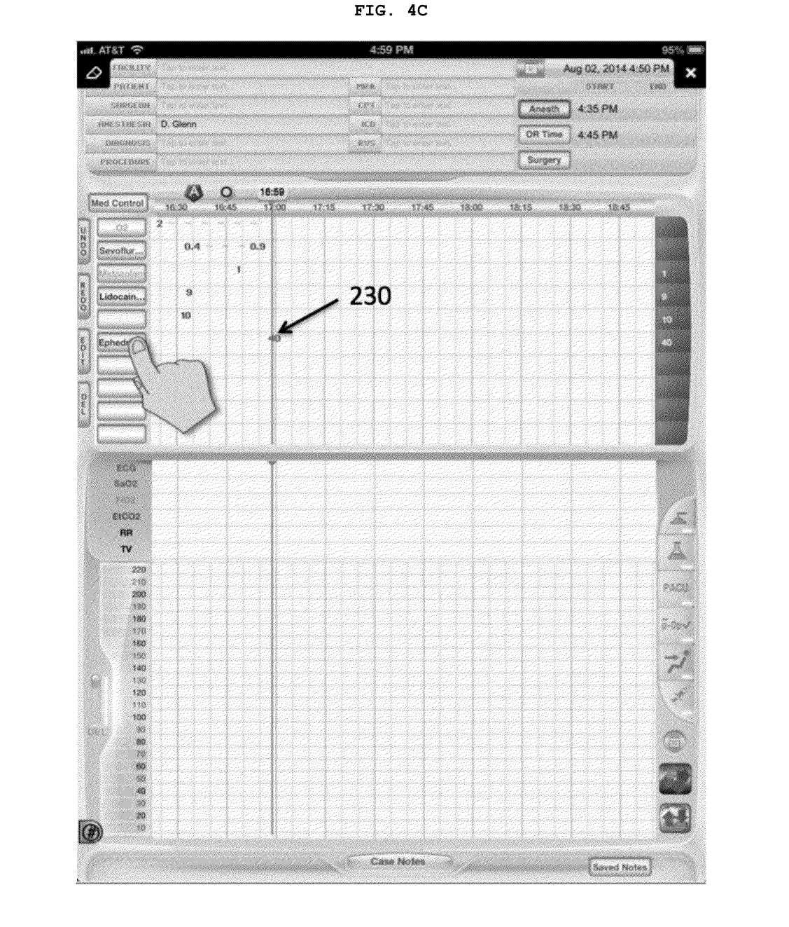

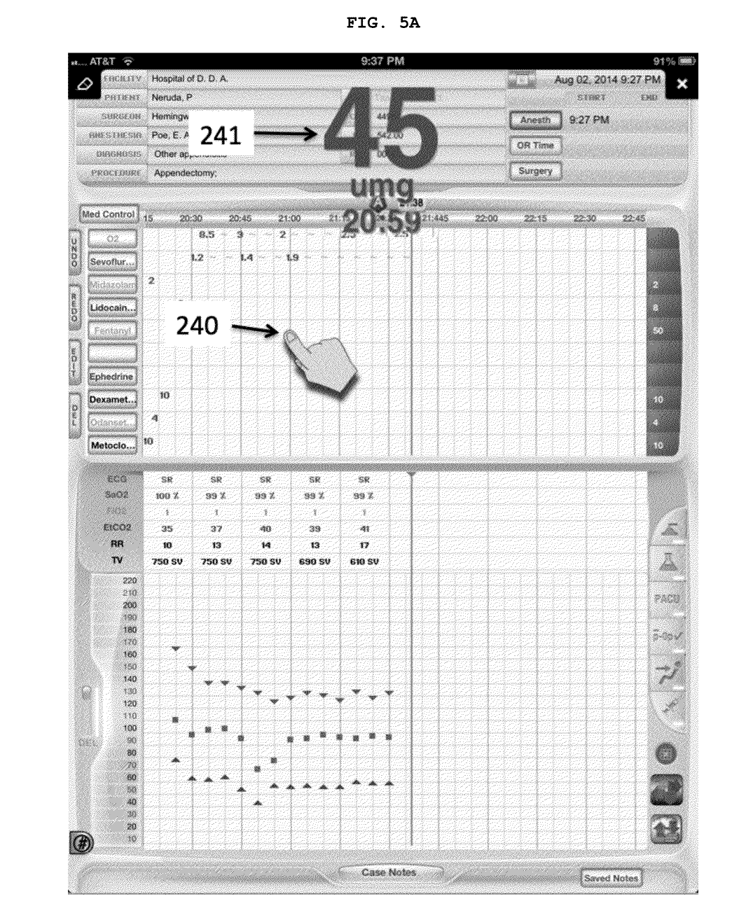

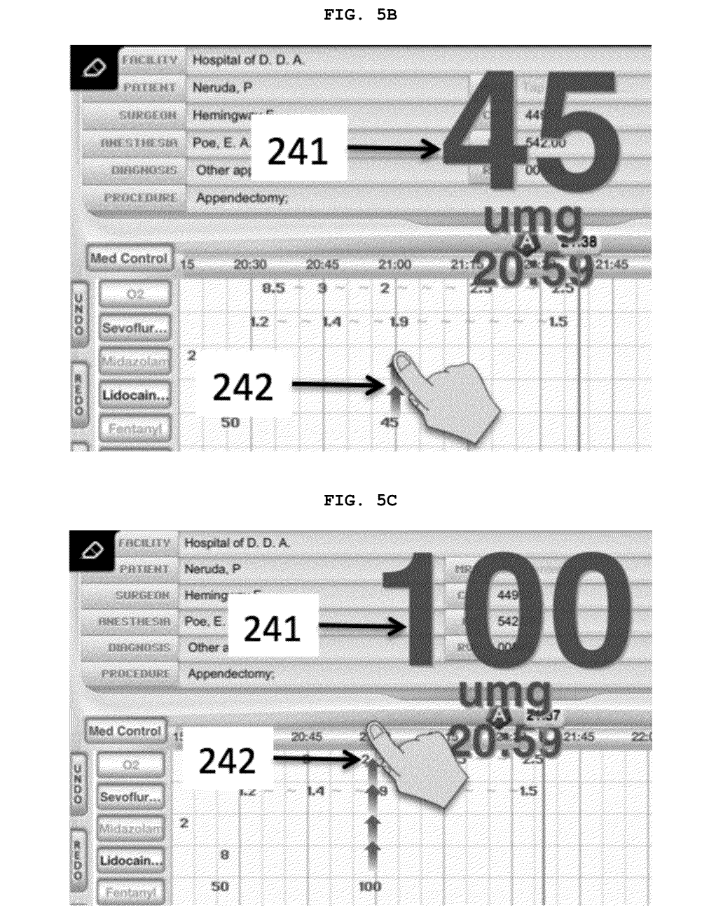

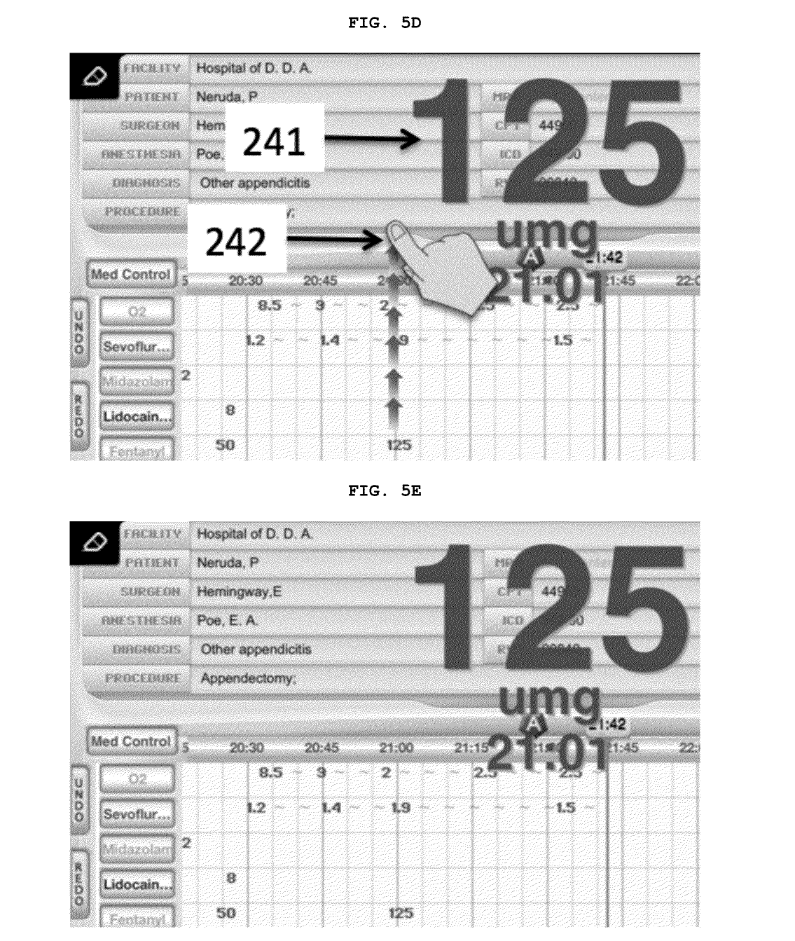

In another embodiment of the invention, the application program operatively enables the anesthesiologist, via gesture-based means, to add medication dosing content before current time on a multi-function gesture-sensitive device. FIG. 5A represents a scenario where current time has advanced beyond where the anesthesiologist has entered values. This may happen when the anesthesiologist must turn his attention away from the application program and to the patient. At a time medically feasible, the anesthesiologist will enter the doses administered to catch up to current time. The anesthesiologist will perform the following process for entering the dose:
The anesthesiologist performs a first gesture (single-finger touch and hold) (FIG. 5A, 240). The application program will respond to the first gesture in the second sub-view by showing the default dose configured for the medication and time corresponding to the grid location of the first gesture in the fifth sub-view (FIG. 5A, 241).
While performing a second gesture, different from the first (single-finger vertical slide), the action of an up gesture results in a higher dose and a down gesture for a lower dose. The application program allows the anesthesiologist, via the sixth sub-view, to configure an increment value for each medication. As the anesthesiologist slides, the application program adds the increment to the dose, such that, the longer the up gesture the more increments are added (FIG. 5B, 5C, 5D, 242). Summarily, a down gesture decrements by the increment. The fifth sub-view will update as the anesthesiologist continues the second gesture (FIG. 5B, 5C, 5D, 241). The application program records the dose when the second gesture ends (lifts single-finger) (FIG. 5E).

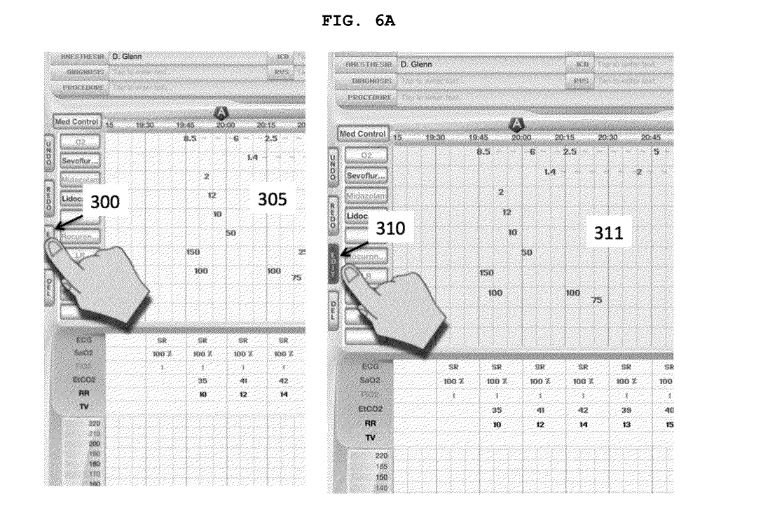

In another embodiment of the present invention, the application program will operatively enable, via gesture-based means, a means of editing previously recorded medication dosing content on a multi-function gesture-sensitive device. There are two reasons to edit a dose, first, to change the amount of dosage. Second, to change the time of the dosage. The anesthesiologist will perform the following process for editing the time of a previously recorded dose:
The anesthesiologist will perform a first gesture (single-finger tap on the “Edit” user interface control) (FIG. 6A, 300, 310). The application program puts the second sub-view into edit mode where it is ready to respond to the second gesture. In addition, the application program changes the background color of the second sub-view from the first color (FIG. 6A, 305) to the second color (FIG. 6A, 311) to help the anesthesiologist identify the mode of the application.
The anesthesiologist will perform a second gesture, different from the first (single-finger touch and hold), over an existing dose in the second sub-view. The application program will respond by placing a crosshair at the focus of the gesture (FIG. 6B, 320) and display the dose along with its units in the fifth sub-view (FIG. 6B, 322).
The anesthesiologist will perform a third gesture (single-finger slide to the left or right). As the anesthesiologist is performing the gesture, the application program will update the time corresponding to the current focus of the gesture in real-time in the fifth sub-view (FIG. 6B, 321, 322). The application will also track the focus of the gesture by updating the crosshair (FIG. 6B, 321). When the third gesture ends (single-finger lifted from the gesture-sensitive display), the application program will hide the fifth sub-view and crosshair.
The anesthesiologist will repeat the first gesture and the application program will return the second sub-view to the default mode. The application program will also change the background color of the second sub-view back to the first color (FIG. 6A, 305).

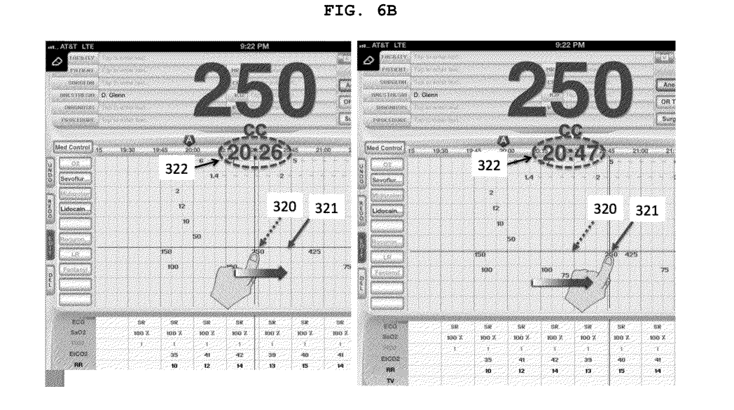

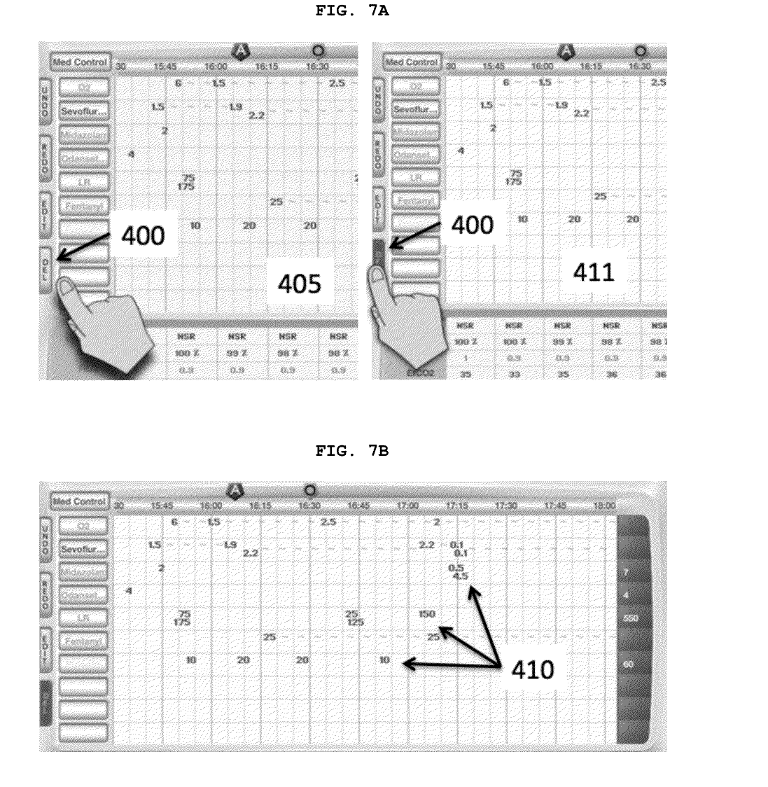

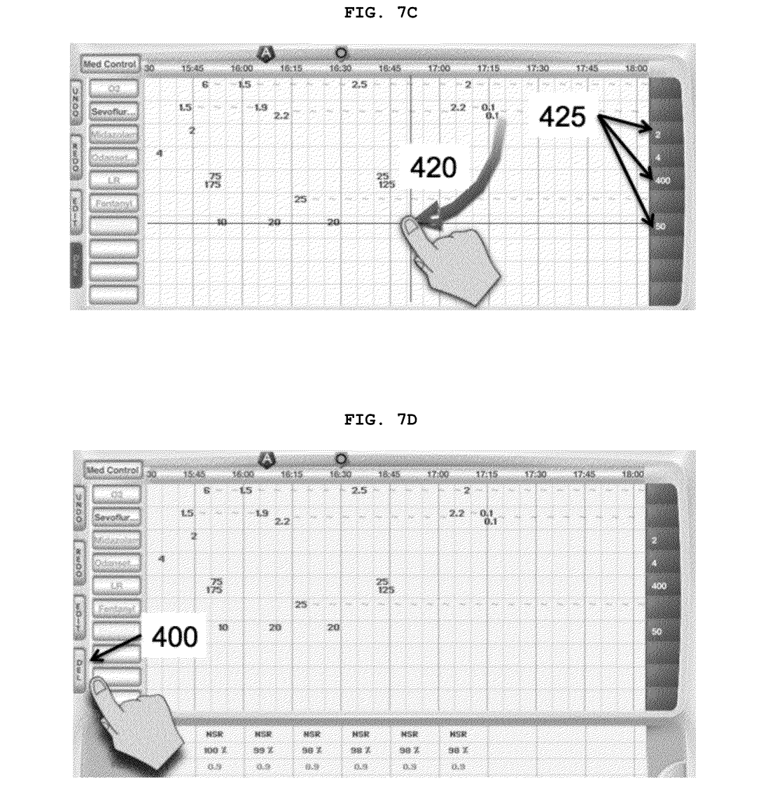

In another embodiment of the present invention, the application program will operatively enable, via gesture-based means, a means of deleting medication dose content on a multi-function gesture-sensitive device. The anesthesiologist will perform the following process for deleting medication dose content:
The anesthesiologist will perform a first gesture (single-finger tap on the “Delete” user interface control) (FIG. 7A, 400). The application program puts the second sub-view into delete mode where it is ready to respond to the second gesture. In addition, the application program changes the background color of the second sub-view from the first color (FIG. 7A, 405) to the third color (FIG. 7A, 411) to help the anesthesiologist identify the mode of the application.
The anesthesiologist will perform a second gesture, different from the first (single finger slide), over one or more existing doses in the second sub-view (FIG. 7B, 410). As the focus of the second gesture passes over a dose, the application program removes it from the second sub-view (FIG. 7C, 420). The application program will also recalculate the sum of all doses for each effected row and change the value displayed in the third sub-view (FIG. 7C, 425).
The anesthesiologist will repeat the first gesture and the application program will return the second sub-view to the default mode (FIG. 7D, 400). The application program will also change the background color of the second sub-view back to the first color (FIG. 7A, 405).

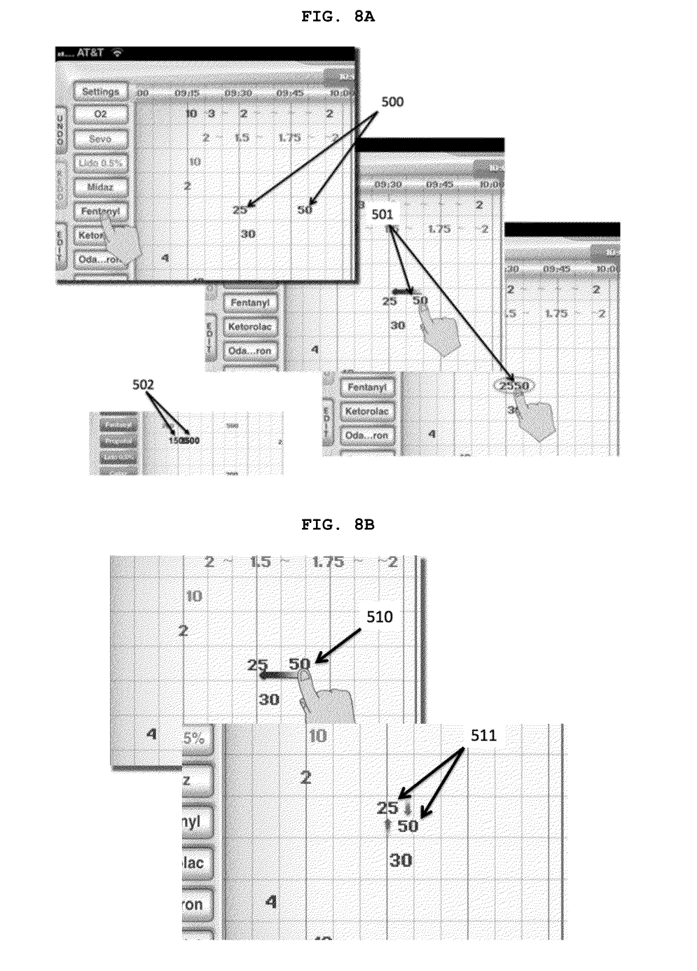

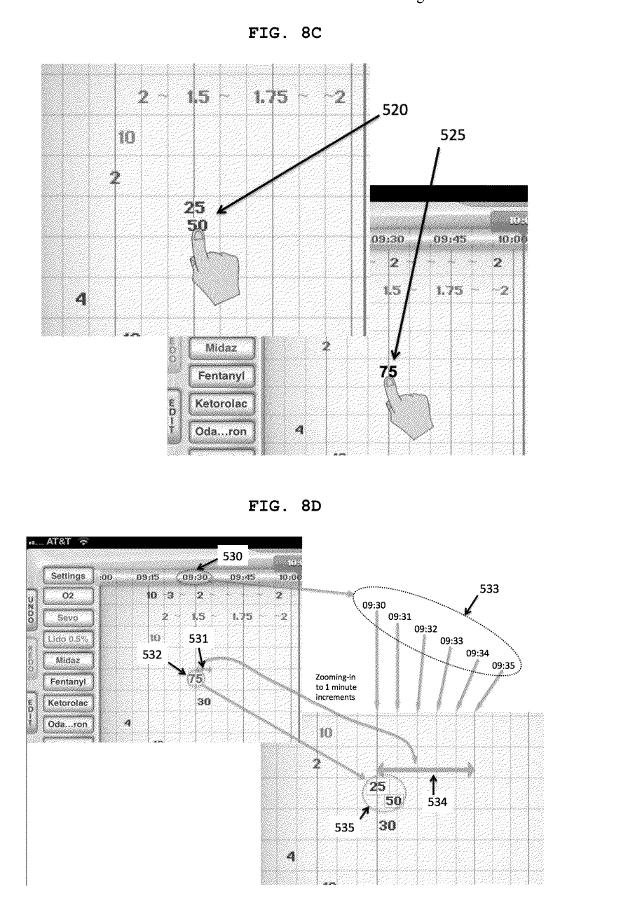

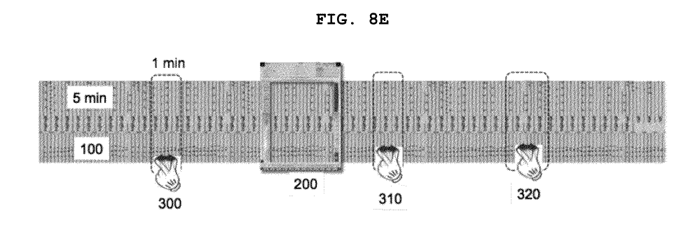

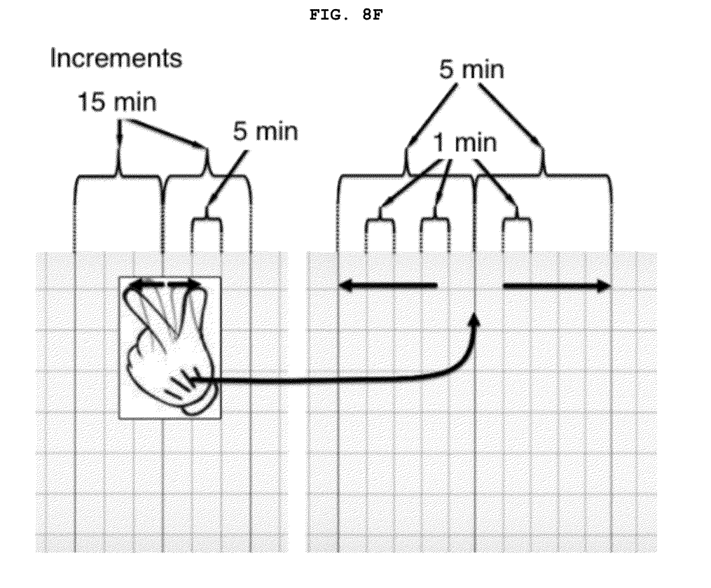

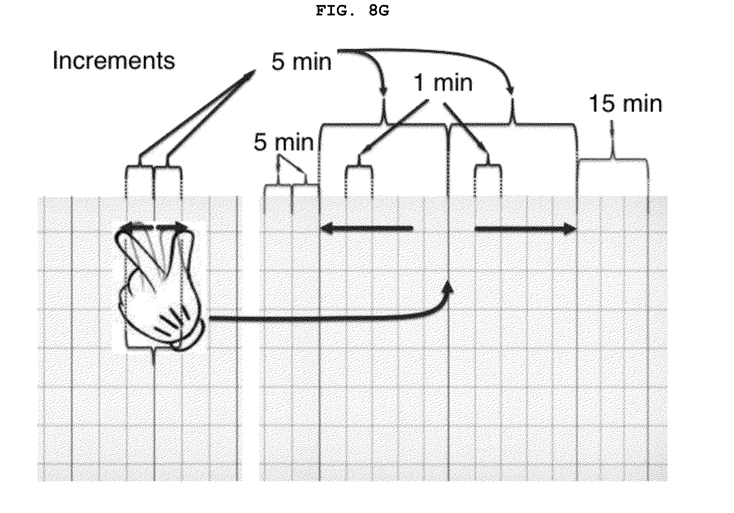

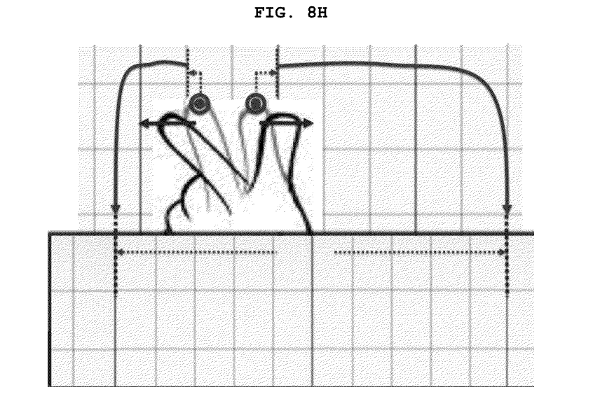

In another embodiment of the present invention, the application program will operatively enable, via gesture-based means, a means of changing the time resolution of the electronic anesthesia record on a multi-function gesture-sensitive device. Due to the size and width of the fonts, numerical entries in the second sub-view can appear to be covering relatively large periods. This is normal and medical convention. However, when the anesthesiologist needs to dose the patient in close proximity, the digits may overlap and become difficult to read (FIG. 8A, 502). The other possibility that two doses, if closely applied, will appear to be one dose, such as “40” and “40” appears as “4040” (FIG. 8A, 501). The application program provides two solutions to this problem. First, the application program automatically shifts up or shifts down the numerical entries, within the boundary of the upper and lower row lines (FIG. 8B, 510, 511). Second, if the anesthesiologist enters a dose within 15 seconds of another dose, the application program will display a single number that is the sum of the two numbers (FIG. 8C, 520, 525). When numerical entries are summed (FIG. 8D, 532), the individual times and dosage amounts will be stored by the application program. To see doses closely entered by time, the anesthesiologist must increase the time resolution. In a higher resolution the displayed summed number will un-sum (FIG. 8D, 535) and the original distinct entries will be displayed on the grid at their appropriate times and dosages. The second sub-view defaults to a time resolution of 5 minutes per cell. The application program will allow the anesthesiologist to selectively change the time resolution to 1 cell=1 minute from 1 cell=5 minutes (FIG. 8D, 530, 531, 533, 534). The application program further allows for multiple, non-overlapping, shifted areas of the medication grid simultaneously (FIG. 8E, 300, 310, 320). FIG. 8E shows a birds-eye view of the timeline of the case (FIG. 8E, 100) with the portion viewable to the anesthesiologist (FIG. 8E, 200). The portion viewable to the anesthesiologist is changeable via horizontal scrolling (FIG. 9A and FIG. 9B). Shifted areas appear as 1-minute intervals while the remainder of the case, as 5-minute intervals. To change the time resolution of the medication grid, the anesthesiologist will perform the following process:
The anesthesiologist will perform a first gesture (single-handed two-finger horizontal expand) (FIG. 8F, FIG. 5G). The application program determines the region of the second sub-view it will expand by where the anesthesiologist's gesture touches the blood pressure vital sign grid. The first vertical grid lines on the outside of the space between the finger tips, i.e., the grid line immediately to the right of the finger on the right and the grid line immediately to the left of the left finger (FIG. 8H). At the end of the gesture, the region under gesture of the second sub-view will reflect the time of 1 cell=1 minute (FIG. 8I). Upon completion of the gesture, the application program will change the background color of the second sub-view to help visually identify the time-shifted region from the first color to the fourth color (not shown).

In another embodiment of the invention, the application program operatively enables a process to allow the anesthesiologist, via gesture-based means, to horizontally scroll the medication grid on a multi-function gesture-sensitive device. The application program enables an anesthesiologist to change the position of the second sub-view relative to the medication grid. To horizontally scroll the medication grid to a previous point in time, the anesthesiologist will perform a first gesture (two-finger horizontal slide to the right) over the second sub-view (FIG. 9A). To horizontally scroll the medication grid to a later point in time, the anesthesiologist will perform a second gesture (two-finger horizontal slide to the left) over the second sub-view (FIG. 9B). The application program will adjust the time and time related events shown in the fourth sub-view in real time as the anesthesiologist performs either the first or the second gestures.

In another embodiment of the invention, the application program operatively enables a process to allow the anesthesiologist, via gesture-based means, to vertically scroll the medication grid on a multi-function gesture-sensitive device. It is possible for the anesthesiologist to administer more medications in an electronic anesthesia record than the application program can display at once in the first, second and third sub-views. Hence, the application program must allow the anesthesiologist to vertically scroll up and down. To vertically scroll the medication grid up, the anesthesiologist will perform a first gesture (two-finger vertical slide up) over any part of the first, second or third sub-views (FIG. 9C). To vertically scroll the medication grid down, the anesthesiologist will perform a second gesture (two-finger vertical slide down) over any part of the first, second or third sub-views (FIG. 9C).

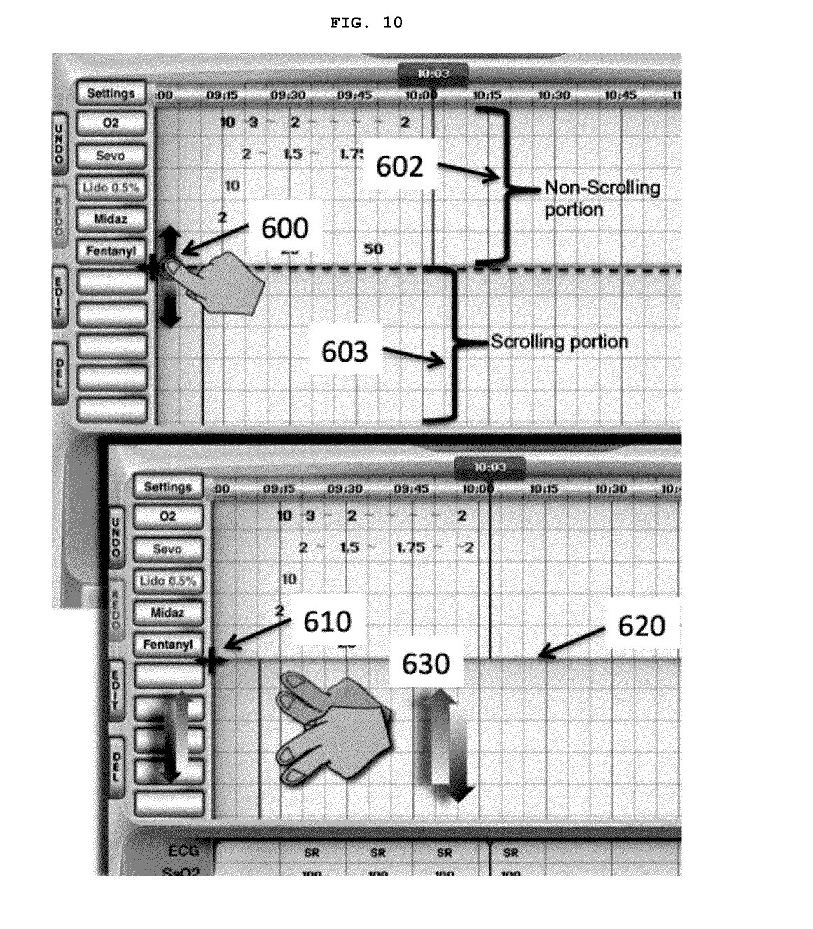

In another embodiment of the invention, the application program operatively enables a process to allow the anesthesiologist, via gesture-based means, to split-scroll, i.e. to vertically split the medication grid into two horizontal regions, one atop the other, the first region (top) being fixed and not vertically scrollable, the second (bottom) being vertically scrollable. It is possible for the anesthesiologist to administer more medications in an electronic anesthesia record than the application program can display at once in the second sub-view. In a representative example, where there are more medications used in the record than can be displayed at once, the anesthesiologist may need to simultaneously view a medication at the top of the medication dosing grid and one at the bottom. The application program allows the anesthesiologist split the first, second and third sub-views via the following process;
The anesthesiologist will perform a first gesture (single-finger touch and hold) (FIG. 10, 600) on a row on the second sub-view. The application responds to the first gesture by displaying a large plus sign on the row line that was the focus of the first gesture and at the border between the first and second sub-views (FIG. 10, 610). The application program also displays a horizontal border (FIG. 10, 620) between the first region (FIG. 10, 602) and the second region (FIG. 10, 603). Medication dosing content in the first region will be fixed and not vertically scrollable. Medication dosing content in the second region will be vertically scrollable (FIG. 10, 630).

In another embodiment of the invention, the application program operatively enables a process to allow the anesthesiologist, via gesture-based means, to expand and magnify the screen area on a multi-function gesture-sensitive device. This embodiment enables an anesthesiologist to better see application content. The application program divides the combined area occupied by the first through fourth sub-views into a first and second area, each equal in size. The application program enables the first and second areas to respond to a gesture (FIG. 11A, 700, 710) resulting in the expansion and magnification. To expand and magnify, the process is as follows:
The anesthesiologist will gesture (FIG. 11B, 720) (single-hand, triple-finger tap) over either the first or second equal area (FIG. 11B, 740). In response, the application program will increase the size of the area to completely full the application window (FIG. 11B, 750). In addition, the application program simultaneously applies a magnification that increases the size of all displayed content by a first magnification of 220%.
The anesthesiologist may optionally perform the gesture a second time anywhere in the application program window and the magnification will increase to a second magnification of 320%.
If the anesthesiologist performed the previous step and then performs the gesture a third time, the application program reduces the magnification back to the first magnification. If after the current step or if the anesthesiologist did not perform the current step, the application program returns the application program window (FIG. 1, 10) back to the state before the first gesture.

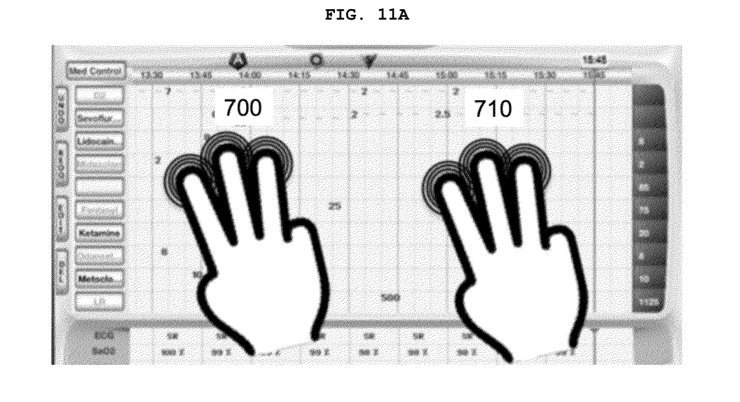

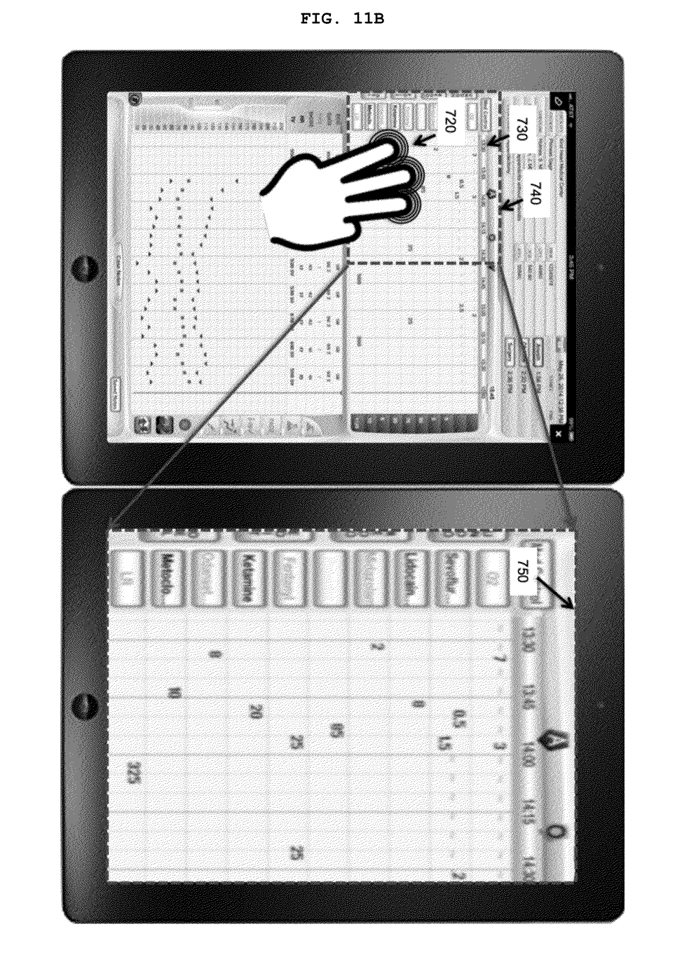

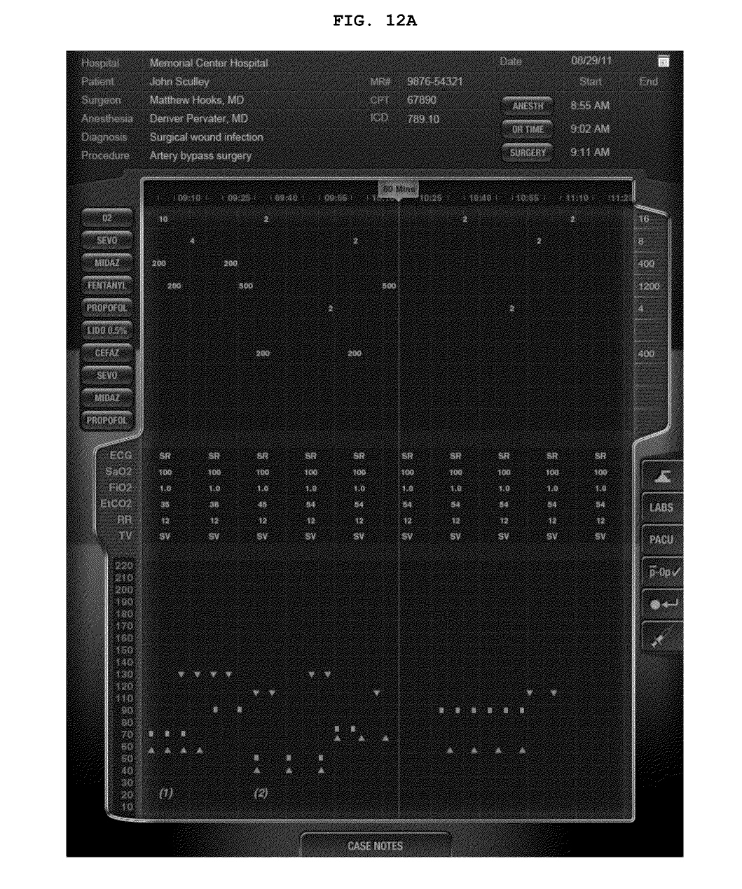

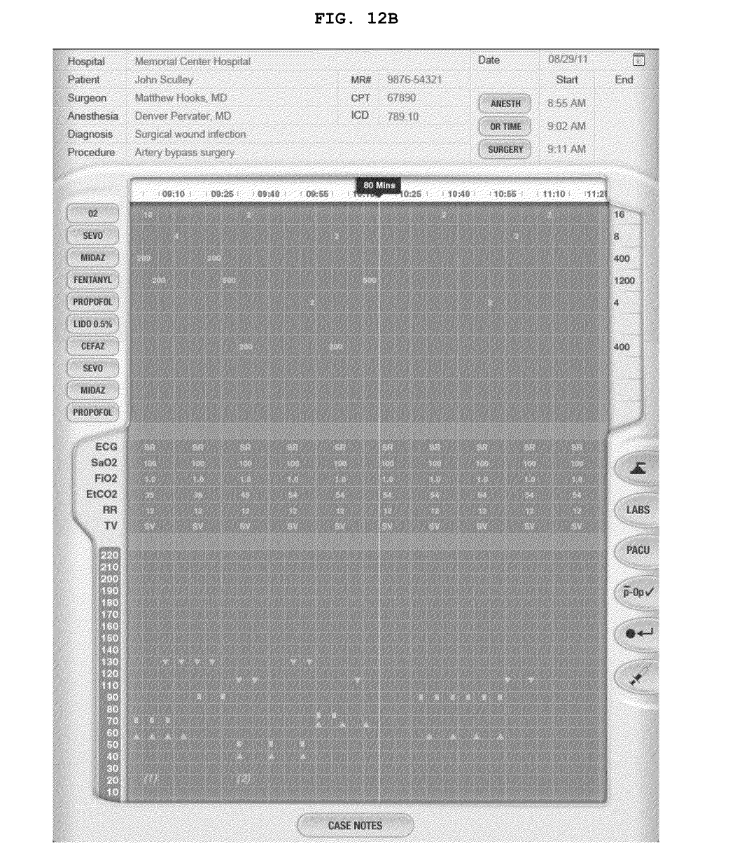

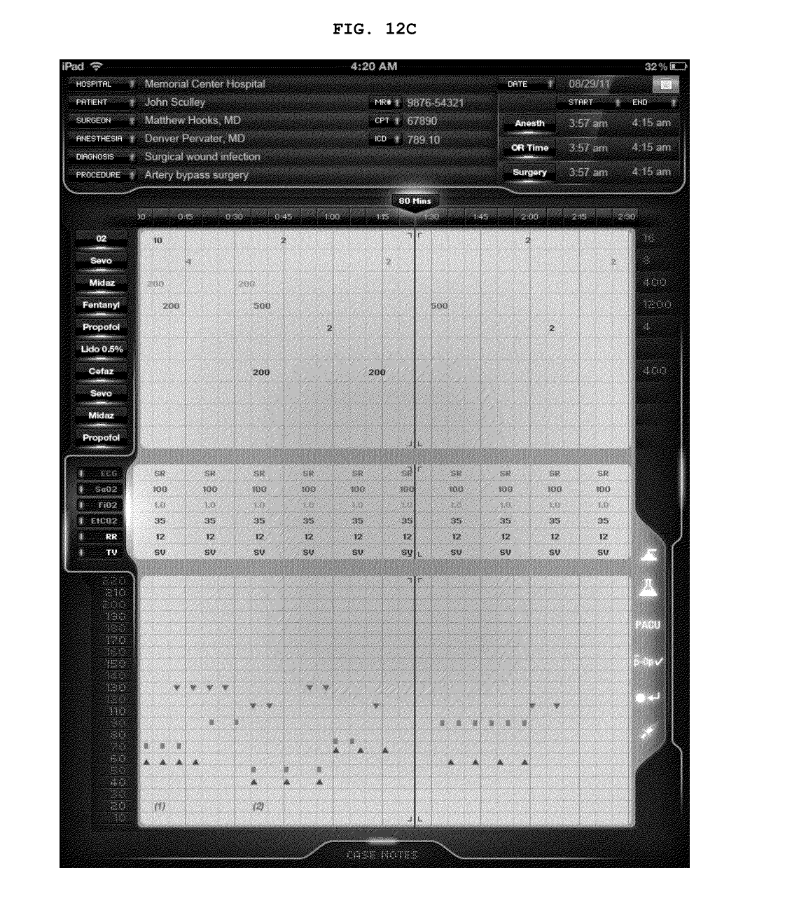

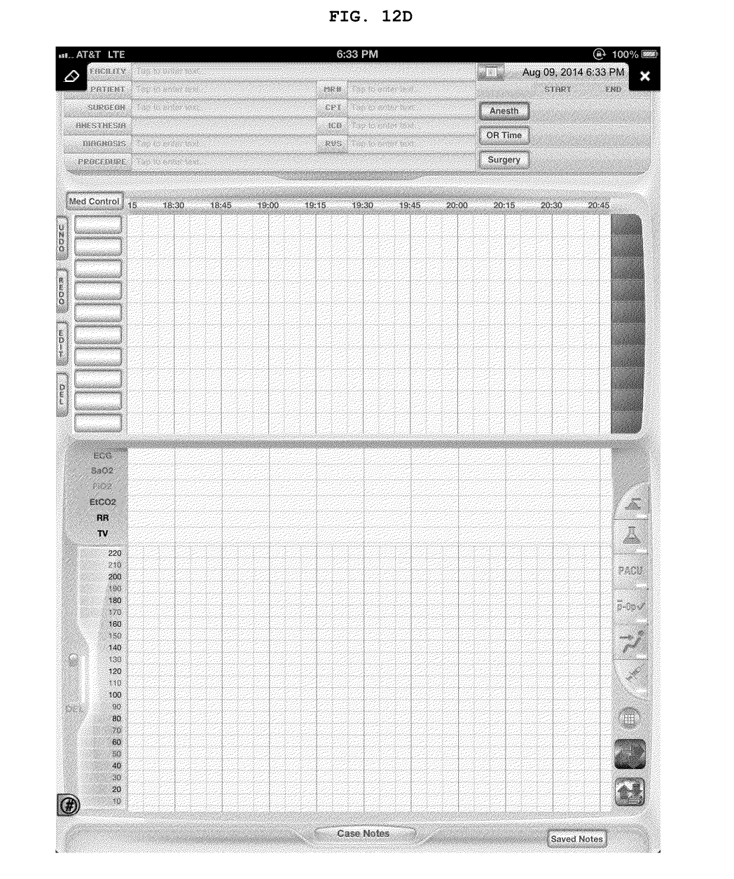

In another embodiment of the invention, the application program operatively enables a means to change the visualization of the invention on a multi-function gesture-sensitive device. This embodiment enables an anesthesiologist to better see the application in different lighting environments frequently encountered in operating room settings. There is also the possibility that the anesthesiologist is wholly or partly color blind requiring this embodiment to best use the application. The application program accomplishes this through a combination of techniques comprising, changing the color palette, the brightness of the gesture-sensitive interface and saturation settings (FIG. 12A-FIG. 12D).

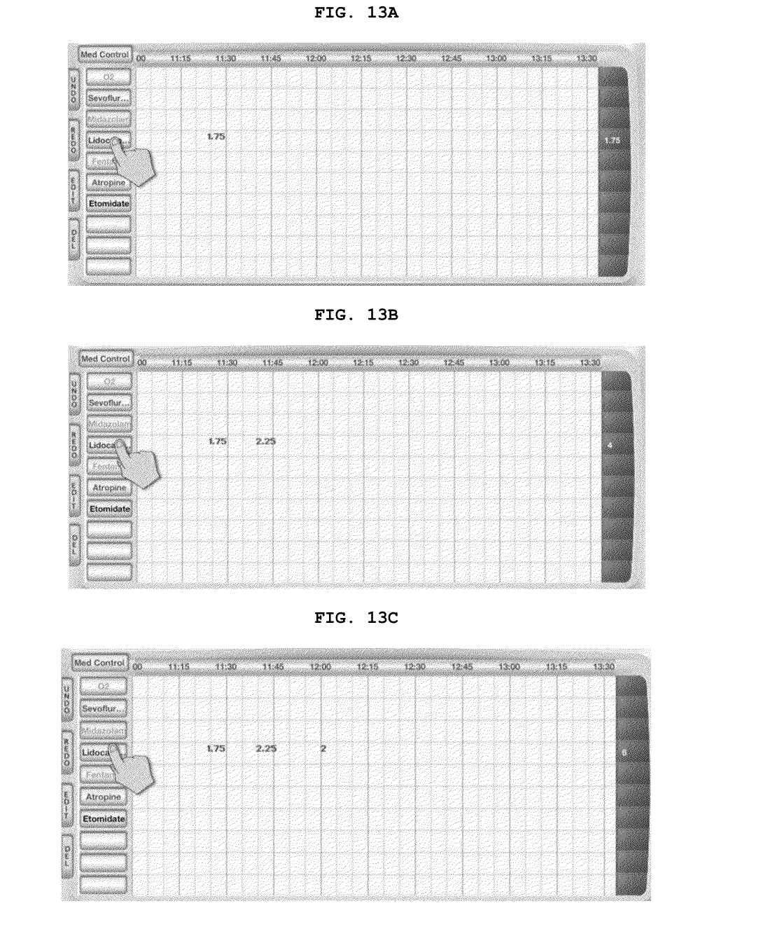

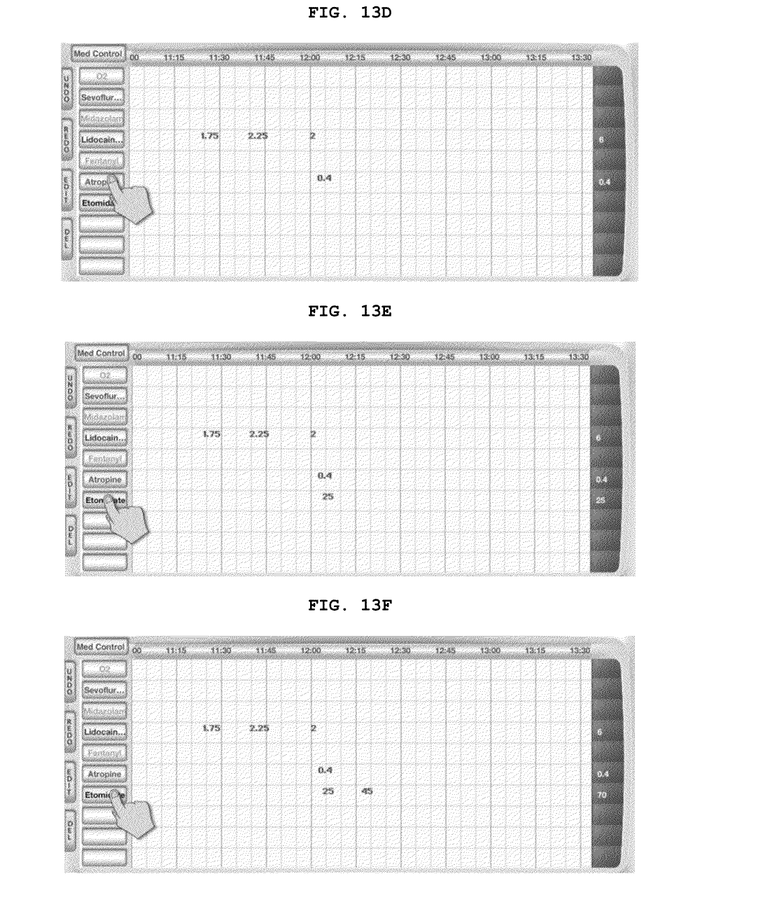

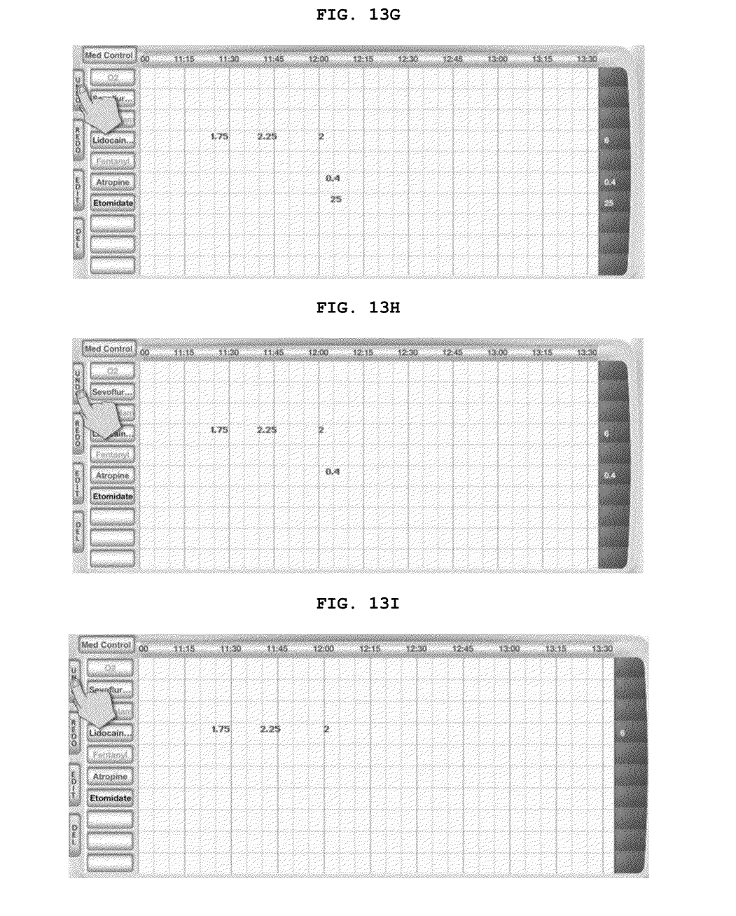

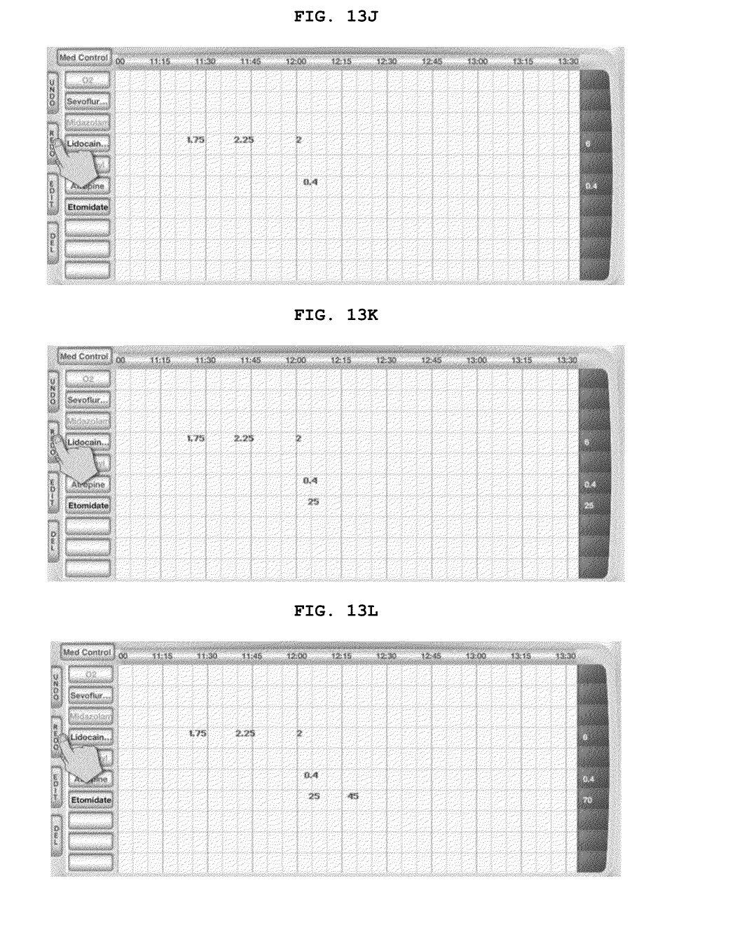

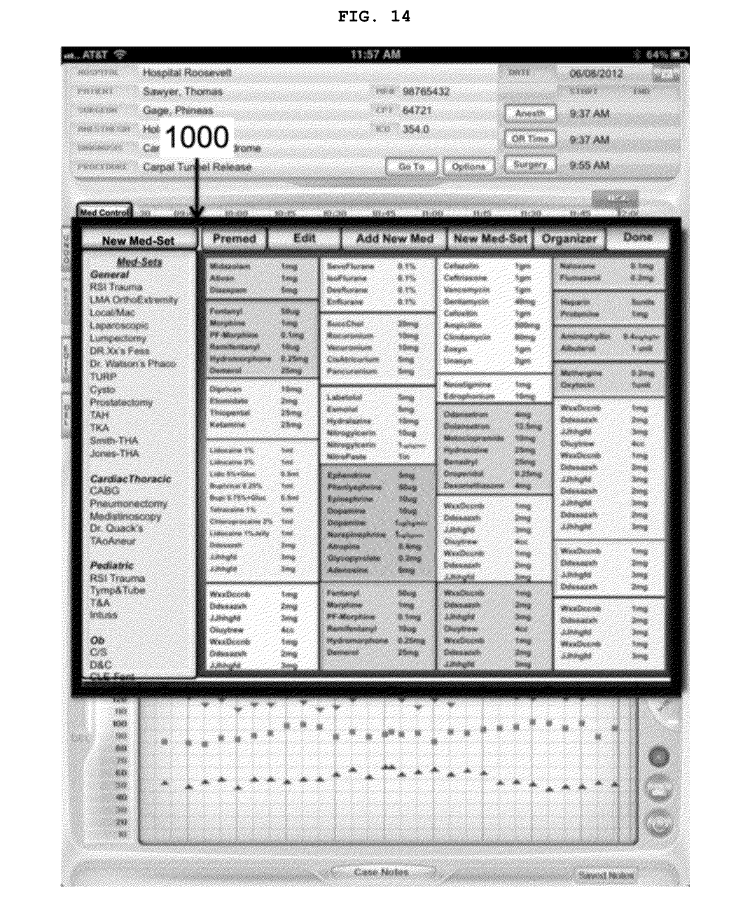

In another embodiment of the invention, the application program operatively enables a means to undo and redo changes to content in the medication dose grid on a multi-function gesture-sensitive device. Undo enables an anesthesiologist to undo the previous 1 to N actions performed on the medication dose grid. Redo reapplies the next 1 to N previously performed actions but previously undone. In a representative example, the anesthesiologist performs a series of dose additions (FIG. 13A-FIG. 13F). Then the anesthesiologist performs the undo embodiment three times (FIG. 13G-FIG. 13I), followed by the redo embodiment three times (FIG. 13J-FIG. 13L).

What is claimed is:

1. A graphical user interface produced by an application program, comprising:
an application program window being generated by the application program on a computing device having a gesture-sensitive interface, the application program window enabling a user to medication dosing content in an electronic anesthesia record, the application window comprising at least a first sub-view, second sub-view, third sub-view, forth sub-view, fifth sub-view and sixth sub-view;
wherein the first sub-view displays a plurality of vertical aligned user interface controls, one user interface control per medication, the label on the user interface control being the name of a medication;
wherein the second sub-view displays, to the right of the first sub-view, at least a portion of a medication grid containing rows and columns, the rows representing a medication and the columns representing time increments advancing forward from left to right, such that a value recorded on the medication grid represents dosing information based on time, each row being horizontally aligned to a single user interface control in the first sub-view to identify the medication being dosed;
wherein the third sub-view displays, to the right of the second sub-view, a single vertical column of numbers, each number being a sum of the doses delivered for a given medication where each number is aligned to a row in the second sub-view;
wherein the fourth sub-view displays a timeline of the electronic anesthesia record based on time of day, such that time progresses from left to right, the timeline comprising a plurality of time increments, each increment being aligned to a column of the second sub-view;
wherein the fourth sub-view displays a plurality of time-based events being tracked by the application program related to the electronic anesthesia record;
wherein the fifth sub-view displays information in real-time under gesture by the user in the second sub-view, such that the application program displays the fifth sub-view above all other user interface controls at the initiation of a gesture and hides the fourth sub-view upon completion of the gesture;
wherein the sixth sub-view displays an apparatus for configuring medication content to be managed by the application program.

2. The graphical user interface as recited in claim 1, wherein the application program window further contains a user interface control configured to permit the user to undo previous actions via gesture based means.

3. The graphical user interface as recited in claim 1, wherein the application program window further contains a user interface control configured to permit the user to redo previous actions via gesture based means.

4. The graphical user interface as recited in claim 1, wherein the application program window further contains a user interface control configured to permit the user to edit a pre-existing medication dose via gesture based means.

5. The graphical user interface as recited in claim 1, wherein the application program window further contains a user interface control configured to permit the user to delete pre-existing medication dosing content via gesture based means.

6. The graphical user interface as recited in claim 1, wherein the application program window further contains a user interface control configured to permit the user to display a graphical user interface means for managing medications under management in the electronic anesthesia record via gesture based means.

7. An apparatus for managing medication dosing content in an electronic anesthesia record, comprising:
means for displaying at least a portion of a grid for managing the medications;
means for displaying at least a portion of a grid for managing medical dosing content;
means for displaying a sum of doses delivered for the on a per medication basis;
means for displaying a timeline of the electronic anesthesia record based on time of day;
means for tracking at least one time-based event associated with the electronic anesthesia record;
means for displaying information in real-time under gesture;
means for configuring medications to be managed.

8. The apparatus as recited in claim 7, wherein the apparatus further includes a means for undoing previous actions via gesture based means.

9. The apparatus as recited in claim 7, wherein the apparatus further includes a means for redoing previous actions via gesture based means.

10. The apparatus as recited in claim 7, wherein the apparatus further includes a means for adding at least one default dose at current time for a medication via gesture based means.

11. The apparatus as recited in claim 7, wherein the apparatus further includes a means for notating the dosing of continuously applied medications.

12. The apparatus as recited in claim 7, wherein the apparatus further includes a means for adding a dose for a medication at current time via gesture based means.

13. The apparatus as recited in claim 7, wherein the apparatus further includes a means for adding a dose for a medication not at current time via gesture based means.

14. The apparatus as recited in claim 7, wherein the apparatus further includes a means for deleting at least one dose of at least one medication via gesture based means.

15. The apparatus as recited in claim 7, wherein the apparatus further includes a means for changing the time resolution but which the supplication program displays medical dosing content via gesture based means.

16. The apparatus as recited in claim 7, wherein the apparatus further includes a means by which the application program expands and magnifies medication dose content via gesture based means.

17. The apparatus as recited in claim 7, wherein the apparatus further includes a means for horizontally scrolling the displayed medication dose content under management via gesture based means.

18. The apparatus as recited in claim 7, wherein the apparatus further includes a means for vertically scrolling to change the displayed medication dose content under management via gesture based means.

19. The apparatus as recited in claim 7, wherein the apparatus further includes a means for changing the visual characteristics of at least a portion of the application program window via gesture based means.

20. The apparatus as recited in claim 7, wherein the apparatus further includes a means for split-scrolling via gesture based means.

21. A computer-implemented method, performed by an application program on a gesture-sensitive device, for adding medication dosing content at current time, in an electronic anesthesia record, via gesture based means, the method comprising the steps of:
(a) performing a first gesture over a user interface control representing a medication under management;
(b) in response to the first gesture, adding a default dose for the medication under management to current time;
(c) displaying the updated sum of all doses applied for the medication under management.

22. A computer-implemented method, performed by an application program and shown within an application program window, on a gesture-sensitive device, for editing the time of a pre-existing medication dose in an electronic anesthesia record, via gesture based means, the method comprising the steps of:
(a) performing a first gesture to place the application program into an edit mode;
(b) performing a second gesture over a pre-existing medication dose;
(c) displaying the amount, the units and time of the pre-existing medication dose;
(d) performing a third gesture during which the application program will update the time of the pre-existing medication dose to the time corresponding to the current focus of the gesture in real-time such that movements to the right advance the time closer to current time and movements to the left correspond to previous time;
(e) performing a first gesture a second time to take the application program out of edit mode.

23. A computer-implemented method as recited in claim 22, wherein the method further comprises the step of changing the background color of a portion of the application program window to indicate the application program is in edit mode.

24. A computer-implemented method, performed by an application program and shown within an application program window, on a gesture-sensitive device, for deleting at least one pre-existing medication dose in an electronic anesthesia record, via gesture based means, the method comprising the steps of:
(a) performing a first gesture to place the application program into a delete mode;
(b) performing a second gesture such that as the focus of the gesture passes over a pre-existing dose, the application program deletes it from the electronic anesthesia record;
(c) performing a first gesture a second time to take the application program out of delete mode.

25. A computer-implemented method as recited in claim 24, wherein the method further comprises the step of changing the background color of a portion of the application program window to indicate the application program is in delete mode.

26. A computer-implemented method, performed by an application program and shown within an application program window, on a gesture-sensitive device, for adding medication dose content prior to current time in an electronic anesthesia record, via gesture based means, the method comprising the steps of:
(a) performing a first gesture, in response to which the application program adds a new dose to the application program window, the new dose configured to a predetermined default amount and units, the time of the new dose corresponding to the focus of the first gesture;
(b) displaying the amount, units and time of the new dose;
(c) performing a second gesture such that the action of an up gesture results in the application program adding a preconfigured increment to the dose, the action of a down gesture results in the application program subtracting the preconfigured increment from the dose such that the longer the gesture is performed as judged by distance from the origin of the first gesture, the more increments are added;
(d) displaying the amount, units and the time of the new dose corresponding to the focus of the second gesture in real time.
